(19) United States
(12) Patent Application Publication
(10) Pub. No.: US 2022/0139113 A1
(43) Pub. Date: May 5, 2022

(54) METHOD AND DEVICE FOR DETECTING OBJECT IN IMAGE

(71) Applicant: PIRECO CO,. LTD., Ulsan (KR)

(72) Inventors: Tae Heon KIM, Seoul (KR); You Jin HA, Ulsan (KR); Si Hyeong PARK, Gyeongju-si (KR); Hye Jin MOON, Gyeongsangnam-do (KR); Hyun Deok KANG, Seoul (KR)

(73) Assignee: PIRECO CO,. LTD., Ulsan (KR)

(21) Appl. No.: 17/573,510

(22) Filed: Jan. 11, 2022

Related U.S. Application Data
(63) Continuation of application No. PCT/KR2021/006010, filed on May 13, 2021.

(30) Foreign Application Priority Data
May 13, 2020 (KR) 10-2020-0056872
May 13, 2020 (KR) 10-2020-0057240

(51) Int. Cl. G06V 40/18; G06V 10/44; G06T 3/40; G06T 5/00; G06V 10/22; G06T 7/11; G06T 7/62; G06V 20/60

(52) U.S. Cl. CPC G06V 40/193; G06V 10/44; G06T 3/40; G06T 5/002; G06T 2207/20021; G06T 7/11; G06T 7/62; G06V 20/60; G06V 10/22

(57) ABSTRACT

The present disclosure relates to a method of an electronic device identifying an object in an image. A method of an electronic device identifying an object in an image according to an embodiment may include acquiring an image including the object; determining a plurality of guide regions of different scales corresponding to the object in the acquired image; identifying the type of object in the image on the basis of feature information that is for identifying the object and that is determined from some guide regions among the plurality of guide regions; and storing at least one pixel value of the image including the object when the identified type of object is identified as an object related to an animal's eye or when the identified type of object is identified as an object related to an animal's nose.

### CROSS-REFERRENCE TO RELATED APPLICATIONS

This application is a Continuation of International Application No. PCT/KR2021/006010, filed on May 13, 2021, which claims priority to and the benefit of Korean Patent Application No. 10-2020-0056872, filed on May 13, 2020, and Korean Patent Application No. 10-2020-0057240, filed on May 13, 2020, the disclosures of which are incorporated herein by reference in its entirety.

### TECHNICAL FIELD

The present disclosure relates to an electronic device and method for identifying an object in an image and, more particularly, to an electronic device and method for identifying an object in an image including at least one object.

### BACKGROUND ART

Along with the development of information and communication technology, techniques for identifying objects included in a video image including a plurality of frames are being developed. In particular, techniques that allow an electronic device to identify objects in a video by itself or to identify a predetermined object by applying a human recognition method to the electronic device are being developed.

Also, the development of a technique that acquires human biometric information from a video on the basis of the recent video recognition technique and uses the acquired biometric information to perform biometric authentication as an authentication scheme for banking, shopping, and unlocking is actively progressing. For example, as a representative biometric authentication scheme, techniques that perform iris recognition through an image of an eye region detected from a video, perform face recognition through an image of a face region detected from a video, and analyzes a fingerprint image detected from a video and then perform fingerprint recognition on the basis of the analysis result are being developed.

However, since an authentication technique using biometric information requires high accuracy due to authentication characteristics, there is still a need to develop a technique for accurately authenticating an object through biometric information. In addition, there is also a need to develop a biometric authentication technique for animals as well as a biometric authentication technique for humans.

### DISCLOSURE

### Technical Problem

According to a disclosed embodiment, there may be provided an electronic device for identifying an object in an image and an operating method thereof. In detail, there may be provided an electronic device for identifying an object related to an animal's eye or nose and an operating method thereof.

### Technical Solution

In order to achieve the above-described technical objects, according to an embodiment of the present disclosure, a method of an electronic device identifying an object in an image may include acquiring an image including the object; determining a plurality of guide regions of different scales corresponding to the object in the acquired image; identifying the type of object in the image on the basis of feature information that is for identifying the object and that is determined from some guide regions among the plurality of guide regions; and storing at least one pixel value of the image including the object when the identified type of object is identified as an object related to an animal's eye or when the identified type of object is identified as an object related to an animal's nose.

In order to achieve the above-described technical objects, according to another embodiment of the present disclosure, an electronic device for identifying an object in an image may include a display; at least one camera; a memory configured to store one or more instructions; and at least one processor configured to execute the one or more instructions, wherein by executing the one or more instructions, the processor may be configured to acquire an image including the object, determine a plurality of guide regions of different scales corresponding to the object in the acquired image, identify the type of object in the image on the basis of feature information that is for identifying the object and that is determined from some guide regions among the plurality of guide regions, and store at least one pixel value of the image including the object when the identified type of object is identified as an object related to an animal's eye or when the identified type of object is identified as an object related to an animal's nose.

In order to achieve the above-described technical objects, according to an embodiment of the present disclosure, there may be provided a computer program product comprising a recording medium on which a program is stored for performing a method of an electronic device identifying an object in an image, the method including acquiring an image including the object; determining a plurality of guide regions of different scales corresponding to the object in the acquired image; identifying the type of object in the image on the basis of feature information that is for identifying the object and that is determined from some guide regions among the plurality of guide regions; and storing at least one pixel value of the image including the object when the identified type of object is identified as an object related to an animal's eye or when the identified type of object is identified as an object related to an animal's nose.

### Advantageous Effects

According to an embodiment of a present disclosure for achieving the above-described technical problem, the electronic device can accurately identify an object related to an animal in an image.

### DESCRIPTION OF DRAWINGS

FIG. 1A is a diagram schematically illustrating a process in which an electronic device identifies an object in an image according to an embodiment.

FIG. 1B is a diagram schematically illustrating a process in which an electronic device identifies an object in an image according to another embodiment.

FIG. 2 is a flowchart illustrating a method of an electronic device identifying an object in an image according to an embodiment.

FIG. 3 is a flowchart illustrating, in detail, a method of an electronic device determining a plurality of guide regions according to a plurality of scales according to an embodiment.

FIG. 4 is a diagram illustrating a method of an electronic device determining a plurality of guide regions according to an embodiment.

FIG. 5 is a flowchart illustrating a method of an electronic device identifying the type of an object in an image on the basis of an object identification result for each of a plurality of guide regions according to an embodiment.

FIG. 6 is a diagram illustrating a method of an electronic device identifying the type of an object in an image on the basis of an object identification result on a per guide region basis according to an embodiment.

FIG. 7 is a diagram illustrating a method of an electronic device preprocessing an image in order to remove at least one type of noise in an image according to an embodiment.

FIG. 8 is a diagram illustrating a process in which an electronic device identifies the type of an object in an image on the basis of feature information determined in some guide region among one or more generated guide regions according to an embodiment.

FIG. 9 is a diagram illustrating a process in which an electronic device detects a contour of an object from a plurality of guide regions according to an embodiment.

FIG. 10 is a diagram illustrating a process in which an electronic device detects a contour from at least one binarized guide region image and identifies the type of an object on the basis of the detected contour according to an embodiment.

FIG. 11 is a diagram illustrating identification conditions used by an electronic device to determine a probability that an object detected in a guide region corresponds to a nose according to an embodiment.

FIG. 12 is a flowchart illustrating a specific method of an electronic device detecting a contour line from a binarized guide region image according to an embodiment.

FIG. 13 is a reference diagram illustrating a specific method of an electronic device detecting a contour line from a binarized guide region image according to an embodiment.

FIG. 14 is a diagram illustrating a first identification condition used by an electronic device to determine a probability that an object detected in a guide region corresponds to an eye according to an embodiment.

FIG. 15 is a block diagram of an electronic device according to an embodiment.

FIG. 16 is a block diagram of an electronic device according to another embodiment.

FIG. 17 is a block diagram of a server according to an embodiment.

FIG. 18 is a diagram illustrating a process of identifying an object in an image by an electronic device and a service interworking with each other according to an embodiment.

### BEST MODE

There may be provided a method of an electronic device identifying an object in an image according to an embodiment, the method including acquiring an image including the object, determining a plurality of guide regions of different scales corresponding to the object in the acquired image, identifying the type of object in the image on the basis of feature information that is for identifying the object and that is determined from some guide regions among the plurality of guide regions, and storing at least one pixel value of the image including the object when the identified type of object is identified as an object related to an animal's eye or when the identified type of object is identified as an object related to an animal's nose.

There may be provided an electronic device for identifying an object in an image according to an embodiment, the electronic device including a display, at least one camera, a memory configured to store one or more instructions, and at least one processor configured to execute the one or more instructions, wherein by executing the one or more instructions, the processor is configured to acquire an image including the object, determine a plurality of guide regions of different scales corresponding to the object in the acquired image, identify the type of object in the image on the basis of feature information that is for identifying the object and that is determined from some guide regions among the plurality of guide regions, and store at least one pixel value of the image including the object when the identified type of object is identified as an object related to an animal's eye or when the identified type of object is identified as an object related to an animal's nose.

### [Mode for Invention]

Terms used herein will be briefly described, and then the present disclosure will be described below.

The terms used herein have been selected as general terms which are widely used at present in consideration of the functions of the present disclosure but may be altered according to the intent of an operator skilled in the art, conventional practice, or introduction of new technology. In addition, specific terms have been arbitrarily selected by the applicant and their meanings will be explained in detail in the corresponding description of the present invention. Therefore, the terms used herein should be defined on the basis of the overall content of the present disclosure instead of simply the names of the terms.

Throughout the specification, when a part is referred to as including a certain element, this means that the part may include other elements rather than excluding other elements unless otherwise stated. Also, terms such as “-er,” “-or,” and “module” used herein refer to an element for performing at least one function or operation and may be implemented with hardware, software, or a combination thereof.

Hereinafter, embodiments of the present disclosure will be fully described with reference to the accompanying drawings in such a way that those skilled in the art can easily carry out the embodiments. The disclosure may, however, be embodied in many different forms and should not be construed as being limited to the embodiments set forth herein. In the accompanying drawings, portions irrelevant to the description of the present disclosure will be omitted for clarity. Moreover, like reference numerals refer to like elements throughout.

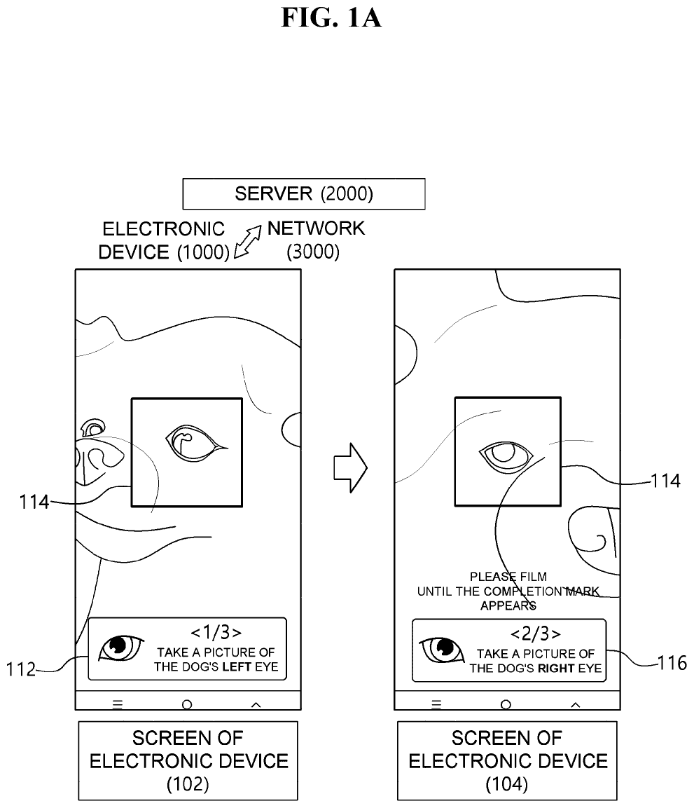

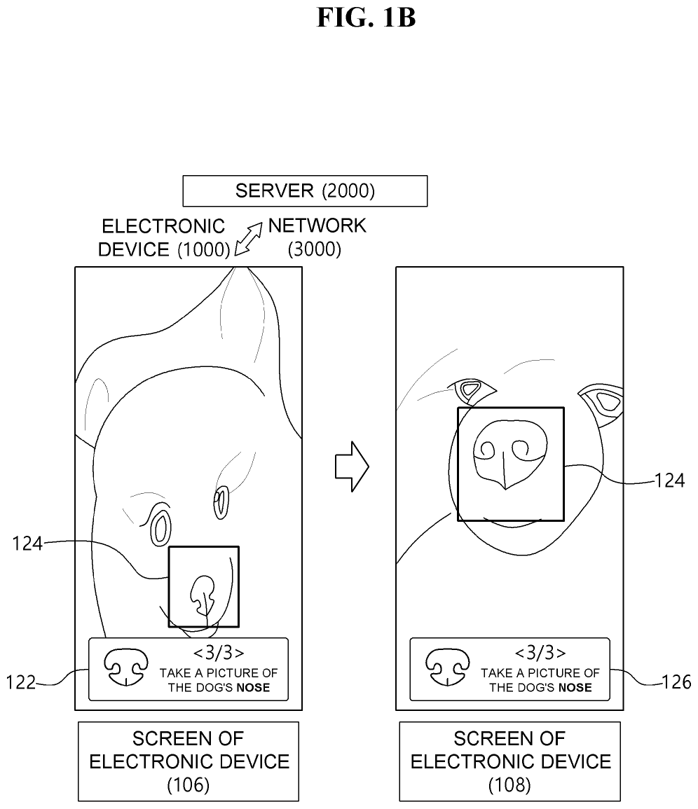

FIG. 1A is a diagram schematically illustrating a process in which an electronic device identifies an object in an image according to an embodiment.

According to an embodiment, an electronic device 1000 may acquire an image including at least one object, identify an object region in the acquired image, and identify the type of an object represented by the identified object region. According to an embodiment of the present disclosure, the electronic device 1000 may acquire an animal image including an animal by capturing an image including the animal using at least one camera.

According to an embodiment, the object identified by the electronic device 1000 may include some body parts of the animal For example, the object identified by the electronic device 1000 may include at least one of the animal's eyes or partial objects related to the animal's eye. According to an embodiment, the partial objects according to the present disclosure may include at least one of eyebrows, pupils, scleras, and animal hair located around the eye region, which are associated with the animal's eye. The electronic device 1000 according to the present disclosure may detect an eye region of the animal or a partial object region including eyebrows, pupils, and scleras, which is a region for the partial objects related to the animal's eye, in the animal image and may identify the type of an object or a partial object in the detected region. According to an embodiment, the electronic device 1000 may acquire an animal image on the basis of a user's input and may display the acquired animal image and also display at least one guide region 114 selected from among a plurality of guide regions on a screen 102. Also, according to an embodiment, while the user captures the animal image, the electronic device 1000 may additionally provide a guide message 112 such as “Please take a picture of the dog's left eye” or a guide message 116 such as “Please take a picture of the dog's right eye”' on a screen 104 for the user's convenience.

The electronic device 1000 according to the present disclosure may identify the type of an object captured in the guide region 114 and may output a guide message for capturing another body part of the animal in the animal image when the identified type of object coincides with a preset object type. According to an embodiment, the electronic device 1000 may identify the type of object included in the guide region 114 in the image acquired based on the user's input. When the identified type of object coincides with the preset object type, the electronic device 1000 may indicate to the user that the image is accurately captured by blinking the guide region 114 at preset intervals or changing the color of the currently displayed guide region 114.

FIG. 1B is a diagram schematically illustrating a process in which an electronic device identifies an object in an image according to another embodiment.

According to an embodiment, an electronic device 1000 may acquire an image including at least one object, identify an object region in the acquired image, and identify the type of an object represented by the identified object region. According to an embodiment of the present disclosure, the electronic device 1000 may acquire an animal image including an animal by capturing an image including the animal using at least one camera.

According to an embodiment, the object identified by the electronic device 1000 may include some body parts of the animal For example, the object identified by the electronic device 1000 may include at least one of the animal's nose or partial objects related to the animal's nose. According to an embodiment, the partial objects according to the present disclosure may include at least one of the animal's nostrils, the philtrum located between the nostrils (e.g., a narrow groove between the nose and the upper lip), and nose hairs located around the nose. The electronic device 1000 according to the present disclosure may detect a nose region of the animal or a partial object region including nostrils, the philtrum, and nose hairs located around the nose, which is a region for the partial objects related to the animal's nose, in the animal image and may identify the type of an object or a partial object in the detected region.

According to an embodiment of the present disclosure, the electronic device 1000 may be implemented as various types of devices including a communication module capable of communicating with a server 2000. For example, the electronic device 1000 may be a digital camera, a mobile terminal, a smartphone, a notebook, a laptop computer, a tablet PC, an e-book terminal, a digital broadcasting terminal, a personal digital assistant (PDA), a portable multimedia player (PMP), a navigation device, an MP3 player, or the like, but the present invention is not limited thereto. Also, according to an embodiment, the electronic device 1000 may be a wearable device which can be worn by a user.

For example, the wearable device may include at least one of accessory-type devices (e.g., watches, rings, wristbands, ankle bands, necklaces, glasses, and contact lenses), head-mounted display devices (HMDs), fabric or clothing-integrated devices (e.g., electronic clothing), body-attached devices (e.g., a skin pad), or bio-implantable devices (e.g., an implantable circuit), but the present invention is not limited thereto.

According to an embodiment, the server 2000 may include other computing devices connected to the electronic device 1000 through the network 3000 to transmit and receive data to and from the electronic device 1000. Also, according to an embodiment, the server 2000 may be a wearable business management server (WBMS) for managing a wearable device. According to an embodiment, the network 3000 includes a local area network (LAN), a wide area network (WAN), a value added network (VAN), a mobile radio communication network, a satellite communication network, and a combination thereof and is a data communication network in a comprehensive sense that enables the network members shown in FIGS. 1A and 1B to smoothly communicate with each other. The network 3000 may include a wired Internet network, a wireless Internet network, and a mobile wireless communication network.

Referring to FIG. 1B, the electronic device 1000 may acquire an animal image on the basis of a user's input and may display the acquired animal image and also display at least one guide region 124 selected from among a plurality of guide regions on screens 106 and 108. Also, according to an embodiment, while the user captures the animal image, the electronic device 1000 may additionally provide guide messages 122 and 126 such as “Please take a picture of the dog's nose” for the user's convenience on screens 106 and 108.

The electronic device 1000 according to the present disclosure may identify the type of an object captured in the guide region 124 and may output a guide message for capturing another body part of the animal in the animal image when the identified type of object coincides with a preset object type. According to an embodiment, the electronic device 1000 may identify the type of object included in the guide region 124 in the image acquired based on the user's input. When the identified type of object coincides with the preset object type, the electronic device 1000 may indicate to the user that the image is accurately captured by blinking the guide region 124 at preset intervals or changing the color of the currently displayed guide region 124. According to an embodiment, the electronic device 1000 may recognize that the type of object in the image acquired based on the user's input is “nose” or “nose-related partial objects” and may additionally store information on an image including the recognized nose or partial objects in the electronic device.

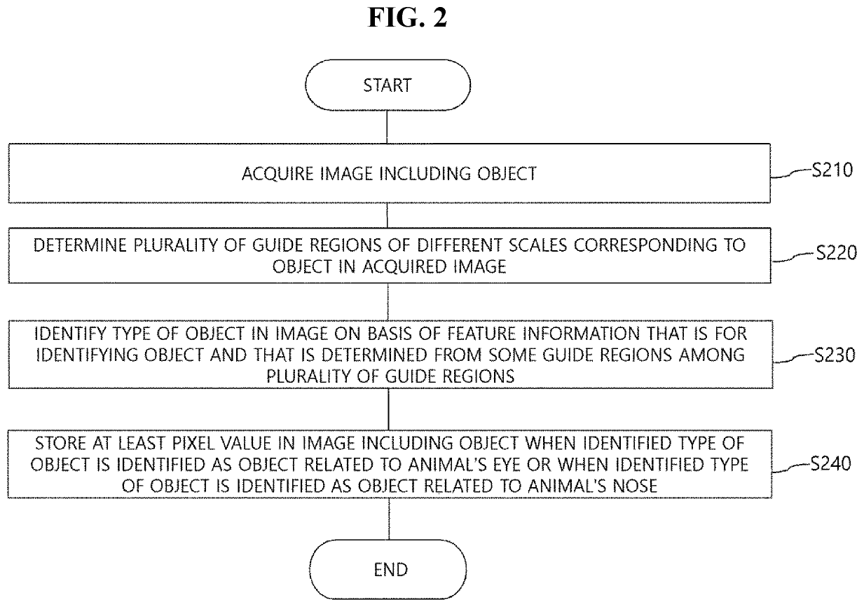

FIG. 2 is a flowchart illustrating a method of an electronic device identifying an object in an image according to an embodiment.

In S210, an electronic device 1000 may acquire an image including an object. For example, the electronic device 1000 may acquire an image using at least one camera included in the electronic device. The electronic device 1000 may acquire a first image and then acquire a second image of the next frame using at least one camera. That is, the electronic device 1000 may acquire a video including a plurality of images for an object.

In S220, the electronic device 1000 may determine a plurality of guide regions corresponding to the object in the acquired image. According to another embodiment, the electronic device 1000 may determine at least one guide region corresponding to the object in the acquired image. For example, the electronic device 1000 may generate a first guide region and may generate a plurality of second guide regions by scaling the generated first guide region according to a preset scale. According to an embodiment, the electronic device 1000 may display the first guide region on the screen of the electronic device and may not display the second guide regions on the screen of the electronic device. According to an embodiment, the second guide regions are not displayed on the screen of the electronic device but may be used for the electronic device 1000 to identify the object in the image.

According to an embodiment, the electronic device 1000 may determine the first guide region according to a preset location. According to another embodiment, the electronic device 1000 may acquire a sensor value corresponding to the user's motion through at least one sensor included in the electronic device and may determine the coordinates of the first guide region on the basis of the acquired sensor value.

In S230, the electronic device 1000 may determine feature information for identifying an object from some of the plurality of guide regions and may identify the type of object in the image on the basis of the determined feature information. For example, the electronic device 1000 may extract some guide regions from among the plurality of guide regions and may determine feature information for identifying an object from the extracted guide regions. The electronic device 1000 may identify the type of object using the feature information determined from the some guide regions.

More specifically, the electronic device 1000 may use a contour for an object detected from the plurality of guide regions to determine coordinate information of the contour and may determine feature information on the basis of the coordinate information of the contour. For example, the electronic device 1000 may detect a first partial contour of the animal's nostrils and a second partial contour of the animal's philtrum line from the plurality of guide regions or some of the plurality of guide regions and may determine feature information on the basis of an identification condition regarding a relative location between the first partial contour and the second partial contour.

According to another embodiment, the electronic device 1000 may determine the identification conditions regarding the relative locations of the first partial contour and the second partial contour on the basis of coordinate information of the first partial contour and coordinate information of the second partial contour included in the feature information and may identify the type of object in the image using feature information generated by weighted-summing scores for the determined identification conditions.

According to an embodiment, the feature information, which is information necessary to identify the type of a preset object in a guide region, may include contour information of a corresponding object, an identification condition regarding a relative location between partial contours of the corresponding object, and information indicating whether the corresponding object is the preset object on the basis of the identification condition. According to another embodiment, the feature information used by the electronic device 1000, which is image information that may be determined based on pixel information of the image, may be provided in the form of a vector.

For example, the electronic device 1000 may determine a gradient of pixels in the image corresponding to the guide region and may extract feature information having a vector form using the determined gradient. However, a process in which the electronic device 1000 extracts feature information having a vector form (e.g., a feature vector) is not limited thereto. The electronic device 1000 may extract a feature vector using a feature vector extraction algorithm for extracting feature vectors on the basis of the variations of pixel values.

According to an embodiment, the electronic device 1000 may generate a histogram for each partial region in the image using the gradient of the pixels in the image. The electronic device 1000 may extract a feature vector for identifying an object from a guide region by concatenating bin values of the histogram generated for each partial region. Also, according to an embodiment, before extracting a feature vector, the electronic device 1000 may change the size of the image to a predetermined size by pre-processing images from which the feature vector is to be extracted. The electronic device 1000 may extract a feature vector from an image changed to a predetermined size and may identify an object in the image using the extracted feature vector.

According to an embodiment, the feature vector extracted from the image by the electronic device 1000 may be a descriptor for expressing features of a video. According to an embodiment, the feature vector extracted from the image by the electronic device 1000 may include feature values corresponding to at least one of a Histogram of Oriented Gradients (HOG) feature, Scale Invariant Feature Transform (SIFT) feature, Haar feature, and Ferns feature. However, the present invention is not limited thereto, and the electronic device according to the present disclosure may use a feature extraction algorithm using other pixel values.

For example, the electronic device 1000 may determine at least one partial region by dividing the image corresponding to the guide region. The electronic device 1000 may determine edges of pixels for each of the determined partial regions and determine x-axis components and y-axis components of the determined edges. Also, the electronic device 1000 may determine orientations of the edges using the x-axis components and the y-axis components of the edges for each of the determined partial regions and may generate a histogram having the orientations of the determined edges as a category. The electronic device 1000 may determine the feature vector by concatenating bin values of the histogram generated for each partial region.

According to another embodiment, the electronic device 1000 may identify the type of object in the image by inputting the feature information to an artificial intelligence model. According to an embodiment, before inputting the feature information to the artificial intelligence model, the electronic device 1000 may resize the feature information to a preset size suitable for input to the artificial intelligence model.

According to an embodiment, the artificial intelligence model used by the electronic device 1000 may output a probability for each label in which the type of object is predefined (e.g., nostrils, a nose, and a philtrum line) when the feature information is input. According to another embodiment, when the feature information is input, the artificial intelligence model used by the electronic device 1000 may perform the output as the type of label (e.g., nostrils, a nose, and a philtrum line) object corresponding to the input feature information with the highest probability. According to another embodiment, when the feature information is input, the artificial intelligence model may output a value indicating whether the object in the image corresponding to the feature information is the animal's nose or not.

The artificial intelligence model used by the electronic device 1000 may include an artificial neural network model that is formed in a deep neural network structure having multiple layers or a machine learning model that may be trained according to other artificial intelligence learning algorithms According to an embodiment, the artificial neural network model used by the electronic device may include a Convolutional Neural Network, Deep Neural Network (DNN), Recurrent Neural Network (RNN), Bidirectional Recurrent Deep Neural Network (BRDNN), and Multilayer Perceptron (MLP), but the present invention is not limited thereto.

According to an embodiment, the artificial neural network model used by the electronic device 1000, which is MLP, may be an artificial neural network in a FeedForward form that includes connections between perceptrons of adjacent layers but does not include connections between perceptrons of the same layer. According to another embodiment, the artificial neural network used by the electronic device 1000 may have a structure in which a fully-connected layer is connected to a CNN structure in which a convolution layer and a pooling layer are repeatedly used.

In S240, when the identified type of object is identified as an object related to the animal's eye or when the identified type of object is identified as an object related to the animal's nose, the electronic device 1000 may store at least one pixel value in the image including the object.

For example, when the identified type of object is identified as the animal's eye or partial objects related to the animal's eye, the electronic device 1000 may store at least one pixel value in the image including the object. For example, the electronic device 1000 may acquire an animal image corresponding to a user's input in response to output of a guide message such as “Please take a picture of the left eye.” When the type of object in the acquired image is identified as the animal's left eye, the electronic device 1000 may store information on the currently acquired image in a memory of the electronic device.

According to an embodiment, when the identified type of object is identified as the animal's eye or partial objects related to the animal's eye, the electronic device 1000 may not store information on the entire image but may store only information on pixels in the guide region including the identified object. Also, when the identified type of object is identified as the animal's eye or partial objects related to the animal's eye, the electronic device 1000 may not only store at least one pixel value in the image including the object but also may additionally store the identified type of object matched to the stored at least one pixel value.

According to another embodiment, when the object in the acquired image is identified as the animal's nose, the electronic device 1000 may store information on the image identified as the animal's nose in a memory of the electronic device as a means for authenticating the animal later and may use the image including the nose, which is stored in the memory, for biometric authentication.

According to an embodiment, the electronic device 1000 may acquire an animal image corresponding to a user's input in response to output of a guide message such as “Please take a picture of the dog's nose.” When the type of object in the acquired image is identified as the dog's nose, the electronic device 1000 may store information on the currently acquired image in the memory.

According to an embodiment, when the identified type of object is identified as the animal's nose or partial objects related to the animal's nose, the electronic device 1000 may not store information on the entire image but may store only information on pixels in the guide region including the identified object. Also, when the identified type of object is identified as the animal's nose or partial objects related to the animal's nose, the electronic device 1000 may not only store at least one pixel value in the image including the object but also may additionally store the identified type of object matched to the stored at least one pixel value.

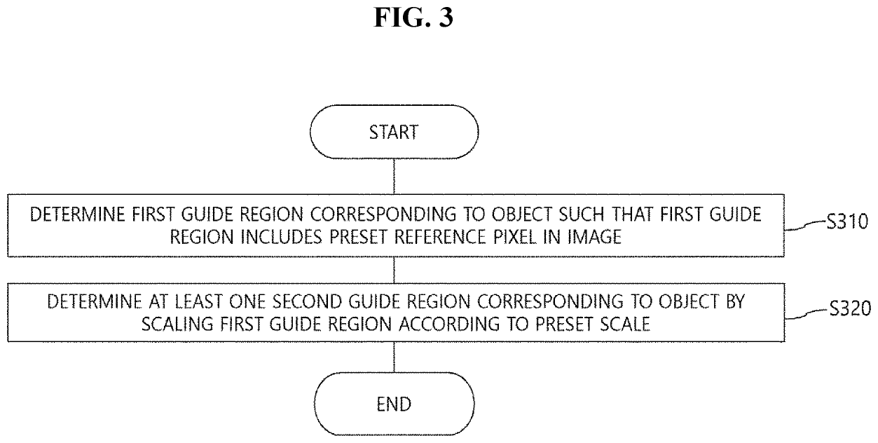

FIG. 3 is a flowchart illustrating, in detail, a method of an electronic device determining a plurality of guide regions according to a plurality of scales according to an embodiment.

In S310, the electronic device 1000 may determine a first guide region corresponding to an object such that the first guide region includes a preset reference pixel in an image. For example, the electronic device 1000 may determine the coordinates of a reference pixel on the basis of the size of the screen of the electronic device and may determine a first guide region such that the first guide region includes the reference pixel located at the determined coordinates.

According to another embodiment, the electronic device 1000 may determine the current orientation of the electronic device and location information indicating a relative relationship between the location of a capture target and the current location of the electronic device on the basis of a sensing value acquired through at least one sensor included in the electronic device and may determine a first guide region on the basis of the orientation and the location information. Also, according to an embodiment, the electronic device 1000 may determine a first guide region in a rectangular shape having line segments extending by a preset width and a preset height from the location of the reference pixel. According to an embodiment, the first guide region may be formed in a square shape, but the present invention is not limited thereto.

In S320, the electronic device 1000 may determine at least one second guide region corresponding to the object by scaling the first guide region according to a preset scale. For example, the electronic device 1000 may determine a second guide region having a width that is 10% longer than that of the first guide region by determining a scaling factor of 1.1 and applying the determined scaling factor to the width of the first guide region. Also, the electronic device 1000 may determine a second guide region having a height that is 10% longer than that of the first guide region by applying a scaling factor of 1.1 to the height of the first guide region.

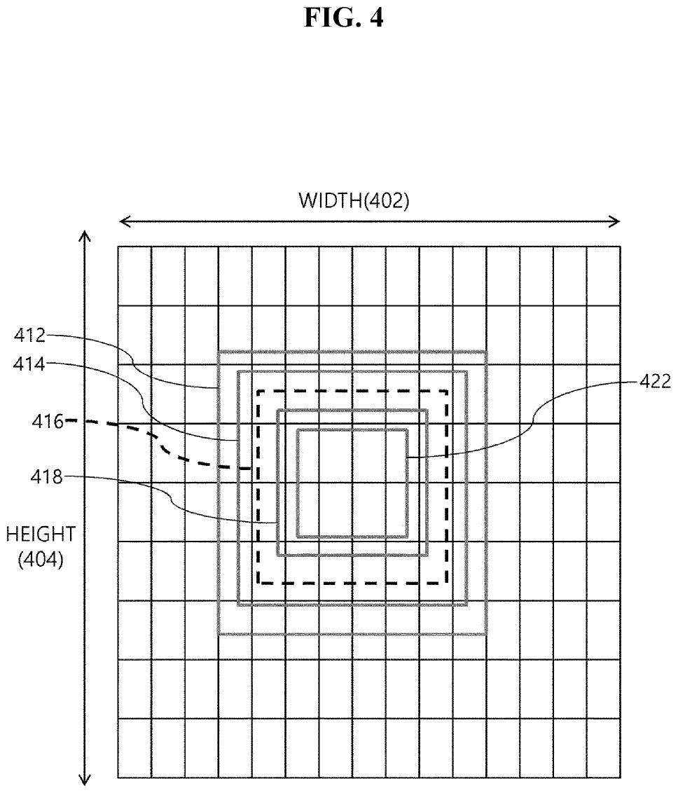

FIG. 4 is a diagram illustrating a method of an electronic device determining a plurality of guide regions according to an embodiment.

As described above with reference to FIG. 3, after determining a first guide region 416, an electronic device 1000 may generate at least one or more second guide regions 412, 414, 418, and 422 by scaling the determined first guide region 416 according to a preset scale. According to an embodiment, the first guide region 416 may be displayed on a screen of the electronic device, but the second guide regions may not be displayed on the screen of the electronic device. The electronic device 1000 may not display the second guide regions generated based on the first guide region on the screen but may use the second guide regions to only a calculation process for identifying an object in the image.

For example, the electronic device 1000 may determine the lower left corner of the first guide region 416 as the coordinates of a reference pixel and may display, on the screen, the first guide region 416 including a width line segment extended by the length of a preset width 402 and a height line segment extended by the length of a preset height 404 from the determined location of the reference pixel. A user of the electronic device may easily determine a capture target region on the basis of a screen of the electronic device displayed in the first guide region 416.

Also, according to an embodiment, the electronic device 1000 may determine a scaling factor for increasing or decreasing at least one of the width or the height of the first guide region and may determine second guide regions by applying the determined scaling factor to the first guide region. According to an embodiment, the electronic device 1000 may determine two second guide regions 412 and 414 each having a greater area than the first guide region and may determine two second guide regions 418 and 422 each having a smaller area than the first guide region.

The electronic device 1000 according to the present disclosure may extract feature information from the first guide region and at least one of the second guide regions and may identify an object in the image using the extracted feature information. However, according to another embodiment, the electronic device 1000 according to the present disclosure may determine a probability of corresponding to an object for each of the first guide region and the second guide regions and may preferentially identify the objects of guide regions on the basis of whether the determined probability is greater than a preset threshold. The electronic device 1000 according to the present disclosure may determine that objects of guide regions having probabilities lower than the preset threshold are not identified and may secondarily identify the type of object using only feature information extracted from guide regions having probabilities higher than the preset threshold. According to another embodiment, the electronic device 1000 may identify the type of object in the image by inputting only the feature information extracted from the guide regions having probabilities higher than the preset threshold to an artificial intelligence model.

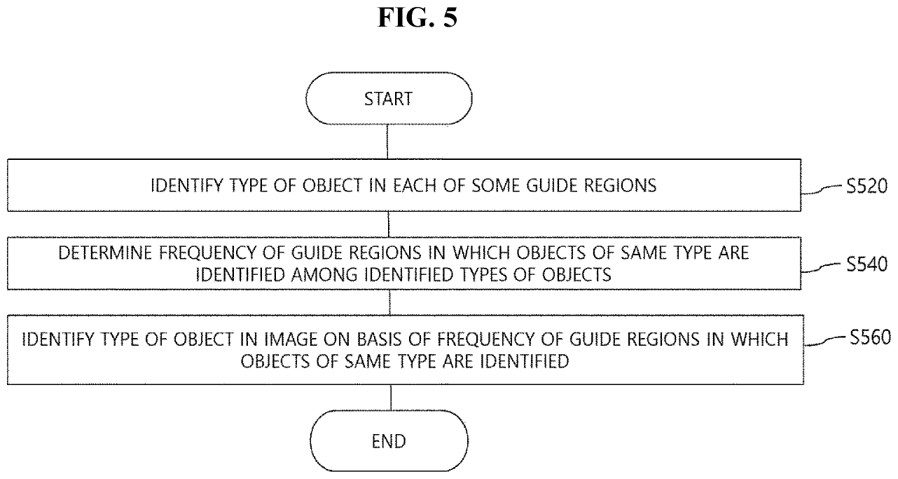

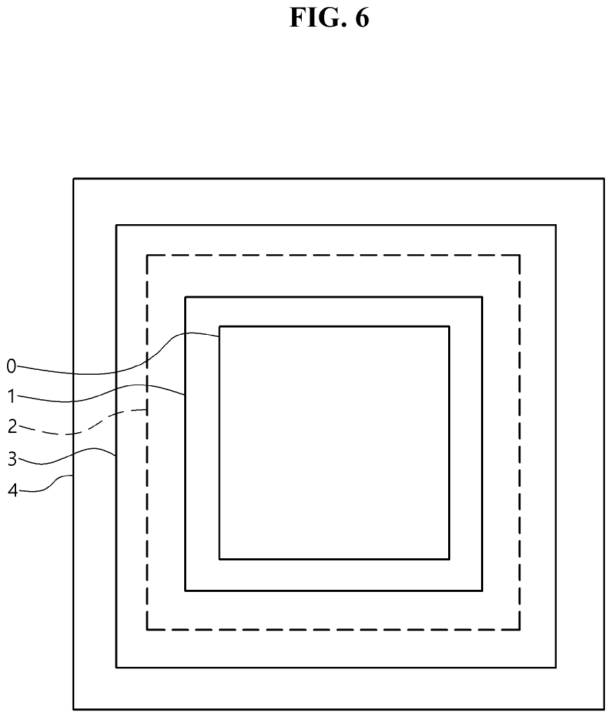

Therefore, the electronic device 1000 according to the present disclosure does not perform an artificial intelligence operation on all of the generated guide regions but preferentially identifies an object according to a preset criterion using feature information extracted for each of at least one guide region and then does not perform a secondary object identification process on guide regions in which no object is identified. Thus, it is possible to increase computation efficiency of the electronic device. A method of the electronic device 1000 identifying the type of object in the entire image on the basis of an object identification value determined for each of a plurality of guide regions will be described below in detail with reference to FIGS. 5 and 6.

FIG. 5 is a flowchart illustrating a method of an electronic device identifying the type of an object in an image on the basis of an object identification result for each of a plurality of guide regions according to an embodiment.

In S520, the electronic device 1000 extracts some guide regions from among a plurality of guide regions (e.g., a first guide region and a second guide region) and identifies the type of an object in each of the extracted guide regions.

For example, the electronic device 1000 may detect a contour for an object for each of the first guide region and the second guide region and may determine a probability that the contour detected for each guide region corresponds to the object by applying different weights to identification conditions that are determined using contour components in the detected contour. The electronic device 1000 may extract some guide regions from among a plurality of guide regions on the basis of a probability that a contour detected for each guide region corresponds to an object. The electronic device 1000 may identify the type of object for each of the extracted guide regions.

In S540, after identifying the type of object for each of the extracted guide regions, the electronic device 1000 may determine the frequency of guide regions in which objects of the same type are identified among the identified types of objects. For example, the electronic device 1000 may compute the number of guide regions in which objects of the same type are identified by counting the types of objects identified for each of the extracted guide regions. In S560, the electronic device 1000 may identify the type of object in the image on the basis of the frequency of guide regions in which objects of the same type are identified. According to an embodiment, the electronic device 1000 may identify the type of object with the largest counts in the guide regions as the type of object in the image.

FIG. 6 is a diagram illustrating a method of an electronic device identifying the type of an object in an image on the basis of an object identification result on a per guide region basis according to an embodiment.

Cases in which an electronic device 1000 identifies the type of object in the entire image using the type of an object identified for each guide region will be described below with reference to FIG. 6. For example, in the case of Embodiment 1, an object corresponding to a first guide region (e.g., Box 0) may be identified as a nose, an object corresponding to a second guide region (e.g., Box 1) may be identified as a nose, and objects corresponding to the other guide regions (e.g., Boxes 2, 3, and 4) may not be identified because probabilities for the other guide regions are determined to be lower than or equal to a preset threshold. In the case of Embodiment 1, the electronic device 1000 may identify that the type of object in the entire image is a nose because the guide regions in which the object is identified as a nose have the highest frequency, i.e., 2. According to an embodiment, while counting the number of guide regions that represent frequencies of the same type, the electronic device 1000 may not count the frequency of guide regions in which no object is identified.

According to another embodiment, for example, Embodiment 2 will be described. In the case of Embodiment 2, an object corresponding to a first guide region (e.g., Box 0) may be identified as a left eye, an object corresponding to a second guide region (e.g., Box 1) may be identified as a nose, an object corresponding to a third guide region (e.g., Box 2) may be identified as a left eye, and objects corresponding to the other guide regions (e.g., Boxes 3 and 4) may not be identified because probabilities for the other guide regions are determined to be less than or equal to a preset threshold.

In the case of Embodiment 2, the frequency of guide regions in which the object is identified as a left eye is 2, the frequency of guide regions in which the object is identified as a nose is 1, and the frequency of guide regions in which no object is identified is 2. Thus, an electronic device 1000 compares the frequency of guide regions in which the object is identified as a left eye to the frequency of guide regions in which no object is identified. However, according to an embodiment, since the frequency of guide regions in which no object is identified may not be used for count calculation, the electronic device 1000 may determine that the frequency of guide regions in which the object is identified as a left eye is highest and then may identify the type of object in the image as the left eye.

According to another embodiment, Embodiment 3 will be described. In the case of Embodiment 3, an object corresponding to a first guide region (e.g., Box 0) may be identified as a left eye, an object corresponding to a second guide region (e.g., Box 1) may be identified as a right eye, an object corresponding to a third guide region (e.g., Box 2) may be identified as a nose, and objects corresponding to the other guide regions (e.g., Boxes 3 and 4) may not be identified because probabilities for the other guide regions are determined to be lower than or equal to the preset threshold.

In Embodiment 3, the frequency of guide regions in which the object is identified as a left eye is 1, the frequency of guide regions in which the object is identified as a right eye is 1, and the frequency of guide regions in which the object is identified as a nose is 1. Thus, the electronic device 1000 may not determine the frequency of guide regions indicating objects of the same type. When the frequency of guide regions indicating objects of the same type is not determined as in Embodiment 3, the electronic device 1000 may determine that the type of object in the image is not identified. When the type of object in the image is not identified, the electronic device 1000 may output a word “none” to the screen.

According to another embodiment, Embodiment 4 will be described. In the case of Embodiment 4, it is assumed that an object corresponding to a first guide region (e.g., Box 0) is identified as a left eye, objects corresponding to second, third, and fourth guide regions (e.g., Boxes 1, 2, and 3) are identified as a nose, and an object corresponding to a fifth guide region (e.g., Box 4) is identified as a right eye. In the case of Embodiment 4, the electronic device 1000 may determine that the frequency of guide regions in which the object is identified as a nose is 3, the frequency of guide regions in which the object is identified as a left eye is 1, and the frequency of guide regions in which the object is identified as a right eye is 1. Therefore, the electronic device 1000 may identify that the type of object in the image is a nose because the guide regions in which the object is identified as a nose have the highest frequency, i.e., 3.

According to another embodiment, Embodiment 5 will be described. In the case of Embodiment 5 , it is assumed that objects corresponding to a first guide region (e.g., Boxes 0 and 1) are identified as a nose, an object corresponding to a third guide region (e.g., Box 2) is identified as a right eye, and objects corresponding to fourth and fifth guide regions (e.g., Boxes 3 and 4) are identified as a left eye. In the case of Embodiment 5, the electronic device 1000 may determine that the frequency of guide regions in which the object is identified as a nose is , the frequency of guide regions in which the object is identified as a right eye is 1, and the frequency of guide regions in which the object is identified as a left eye is 2. Therefore, the electronic device 1000 may currently determine that the frequency of guide regions in which the object is identified as a nose and the frequency of guide regions in which the object is identified as a left eye are higher than the frequency of guide regions in which the object is identified as a right eye. However, since the frequency of guide regions in which the object is identified as a nose and the frequency of guide regions in which the object is identified as a left eye, which are higher than the frequency of guide regions in which the object is identified as a right eye, are equal to each other, i.e., 2, the electronic device 1000 may determine that the type of object in the image cannot be identified. Therefore, similar to the case 606, the electronic device 1000 may output a guide message such as “none” on the screen when determining that the object in the image cannot be identified.

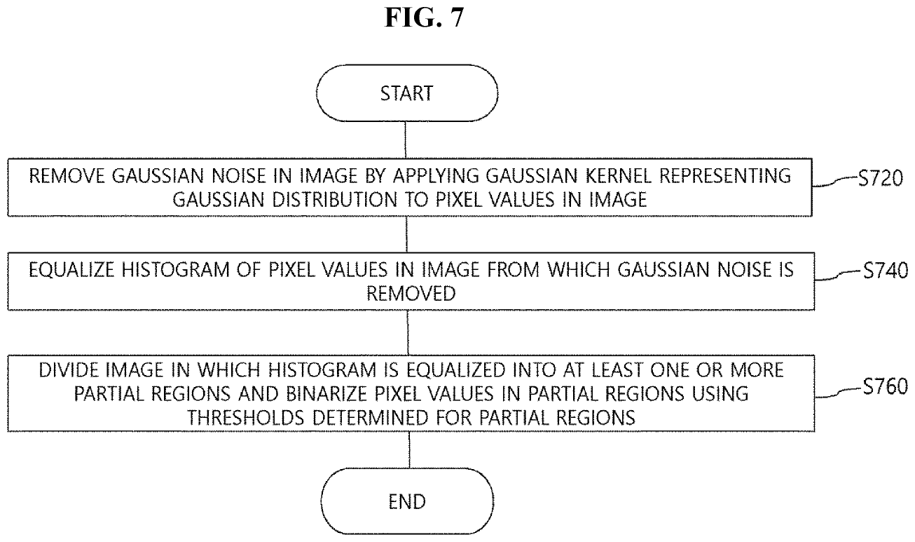

FIG. 7 is a diagram illustrating a method of an electronic device preprocessing an image in order to remove at least one type of noise in an image according to an embodiment.

According to an embodiment of the present disclosure, the electronic device 1000 may preprocess an acquired image in order to remove noise from the image and improve the accuracy of detection of an animal's nose object or eye object. According to an embodiment, in S720, the electronic device 1000 may remove noise from an image by applying a predetermined kernel to pixel values in the image.

According to an embodiment, the electronic device 1000 may remove Gaussian noise in the image by applying a Gaussian kernel indicating the Gaussian distribution. For example, Gaussian distribution noise may be included in an image acquired by the electronic device 1000 along with noise due to the characteristics of an image sensor that captures the image. The noise may degrade the quality of an image or a video including a plurality of images. The electronic device 1000 may remove Gaussian noise in the image by applying a Gaussian kernel that is of a preset size to the image and that indicates the Gaussian distribution. According to an embodiment, the electronic device 1000 may divide the image into predetermined partial regions and apply the Gaussian kernel to each of the partial regions. However, the present invention is not limited thereto, and the electronic device 1000 may remove noise using other image filters for removing noise in images.

In S740, the electronic device 1000 may convert the pixel values in the image from which the noise is removed. According to an embodiment, when the Gaussian kernel is used, the electronic device 1000 may equalize a histogram of the pixel values in the image from which the Gaussian noise is removed. For example, the electronic device 1000 may acquire brightness values for each pixel in the image on the basis of the pixel values in the image. The electronic device 1000 may generate a histogram of the brightness values in the image by classifying the brightness values of the pixels in the image into bins in which the brightness values are classified for each pixel in the image at a predetermined level.

According to an embodiment, the histogram may include a bin including the number of pixels representing a specific brightness value in the image, and the bins may have a predetermined range for classifying the brightness values. The electronic device 1000 may enable the brightness values in the image to be evenly distributed over the entire image by equalizing the histogram indicating the distribution of the brightness values of the image. Also, the electronic device 1000 may increase the contrast of the entire image by equalizing the histogram for the image.

However, according to another embodiment, the electronic device 1000 may equalize the intensity of the pixels in the image rather than the histogram. Also, the electronic device 1000 may equalize the pixel values in the image using other known methods for equalizing pixel values in addition to the above-described equalization method.

In S760, the electronic device 1000 may divide the image with the converted pixel values into at least one or more partial regions and may binarize pixel values in the partial regions using thresholds determined for the partial regions. For example, the electronic device 1000 may convert the image into a grayscale image and may binarize the image using a preset threshold.

However, by dividing an image into one or more partial regions and determining a threshold for each partial region, the electronic device 1000 according to an embodiment of the present disclosure may binarize pixel values for each partial region of the image using a different threshold determined for the corresponding partial region. According to an embodiment, when the image is converted into the grayscale image, the electronic device 1000 may binarize a brightness value for each pixel in the partial region using the threshold determined for the corresponding partial region.

By the electronic device 1000 binarizing the image using different thresholds for the partial regions, it is possible to more accurately detect a contour corresponding to an object from the binarized image. According to another embodiment, the electronic device 1000 may detect a contour of an object from a guide region including a brightness value binarized for each partial region. Also, when the electronic device 1000 uses the histogram equalization scheme according to an embodiment, the electronic device 1000 may divide an image having an equalized histogram into at least one or more partial regions and binarize pixel values in each partial region using a threshold determined for the corresponding partial region.

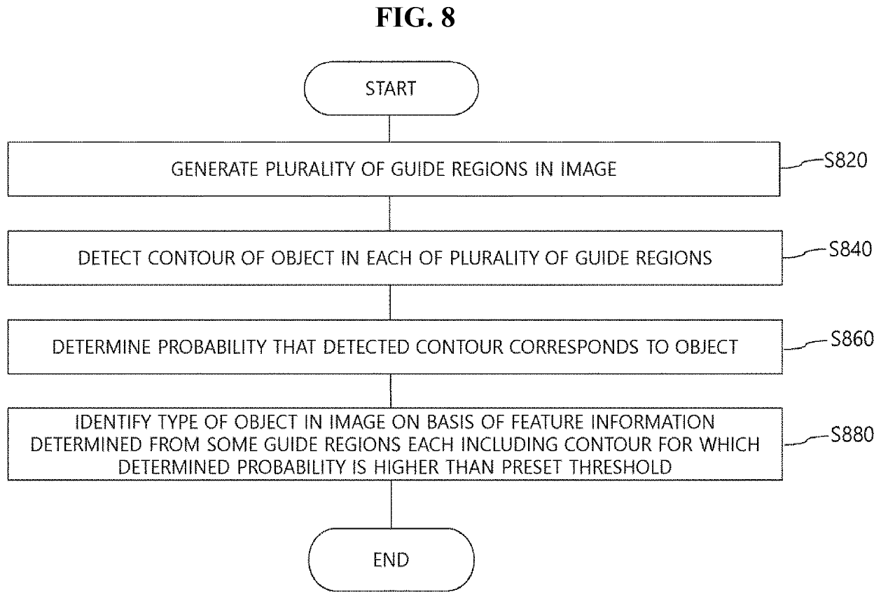

FIG. 8 is a diagram illustrating a process in which an electronic device identifies the type of an object in an image on the basis of feature information decided in some guide regions among one or more generated guide regions according to an embodiment.

In S820, the electronic device 1000 may generate a plurality of guide regions in the image. Operation S820 may correspond to a process in which the electronic device 1000 determines a first guide region and generates second guide regions by scaling the determined first guide region according to a preset scale as described with reference to FIGS. 3 and 4, and thus a detailed description thereof will be omitted.

In S840, the electronic device 1000 may detect a contour of an object in each of the plurality of guide regions. For example, by extracting feature points from a binarized image and identifying a set of points indicating the same image value among the extracted feature points, the electronic device 1000 may detect a contour corresponding to an object in the image. According to an embodiment, the electronic device 1000 may determine a plurality of contours corresponding to an object in the image and determine the max contour among the detected contours.

According to an embodiment, the electronic device 1000 may detect the max contour among the contours detected in the image using a convex hull algorithm. Also, according to an embodiment, by detecting a contour from at least one binarized guide region and then applying a median filter to the detected contour, the electronic device 1000 may further perform a process of smoothing the boundary of the contour. The electronic device 1000 may detect a smoothed candidate contour line as a contour of an object for each of the at least one guide region.

In S860, the electronic device 1000 may determine a probability that the detected contour corresponds to the object. For example, the electronic device 1000 may detect the max contour in each of the plurality of guide regions including a binarized image region and may determine a probability that the detected max contours correspond to objects.

More specifically, the electronic device 1000 may determine contour components of the contour in each of the plurality of guide regions and determine a first identification condition for identifying an object using the determined contour components. By applying different weights to the determined identification conditions, the electronic device 1000 may determine a probability that a contour in each of the plurality of guide regions corresponds to the object.

According to an embodiment, the first identification condition is a condition for line identification of an animal's nose region or eye region in an animal image and may include the area of the detected contour, the coordinates of the detected contour, a ratio between the height and the width of the detected contour, a ratio between the area of the max contour and the area of the contour excluding the area of the max contour.

For example, by using contour components of a contour detected in one guide region, the electronic device 1000 may determine the height of the contour, the width of the contour, the area of the contour, and pixels constituting the contour, the coordinate values of pixels constituting the contour, a coordinate value for a boundary of an ellipse including the pixels, and the area of the max contour among the detected contours. Based on the contour components, the electronic device 1000 may determine first identification conditions including the area of the contour, coordinate information on a boundary of the contour, a ratio between the height and the width of the detected contour (aspect ratio), a ratio between the area of the max contour and the area of the contour excluding the area of the max contour (solidity), and intensities of pixels in an ellipse formed based on the contour.

The electronic device 1000 may determine a first identification condition as described above from a contour detected in one guide region and contour components constituting the contour and then determine scores in which detected contours correspond to items of the first identification condition having different weights. The electronic device 1000 may assign a score for each identification condition to the contour detected in the guide region and then may determine a probability that the contour in the guide region corresponds to the object by weighted-summing the assigned scores according to weights differently assigned depending on the identification condition.

In S880, the electronic device 1000 may determine whether a probability that the contour corresponds to the object determined in each of the plurality of guide regions is higher than or equal to a preset threshold. Also, the electronic device 1000 may identify which of the plurality of guide regions is a guide region including a contour larger than a preset threshold. The electronic device 1000 extracts a guide region including a contour representing a probability higher than the preset threshold from the plurality of guide regions, extracts feature information from only the extracted guide region, and performs the process of identifying the object in the image using the extracted feature information once more.

According to an embodiment, before extracting feature points from guide regions each including a contour for which a probability is higher than the preset threshold, the electronic device 1000 may resize the guide regions to a preset size. The electronic device 1000 may determine feature information from at least one guide region resized to the preset size.

The electronic device 1000 according to the present disclosure can reduce the amount of artificial intelligence computation by determining probabilities that contours extracted from at least one or more guide regions in an image correspond to an object, determining that no object is identified in guide regions in which the determined probabilities are lower than or equal to a preset threshold, extracting feature information from only guide regions in which the determined probabilities are higher than the preset threshold, and inputting the extracted feature information to an artificial intelligence model.

According to another embodiment, the electronic device 1000 may perform a process of identifying an object in an image by performing an additional object identification process corresponding to a second identification condition (e.g., a secondary identification process for an animal's nose object) on the guide regions extracted from among the plurality of guide regions.

That is, by the electronic device 1000 determining a probability of preferentially corresponding to an object in each guide region in an image and then performing a secondary object identification process (a process of identifying an animal's nose object according to a secondary identification condition or identifying an animal's eye object using an artificial intelligence model) using only feature information extracted from guide regions in which a probability of corresponding to an object is high, it is possible to quickly and accurately identify the type of object in the image.

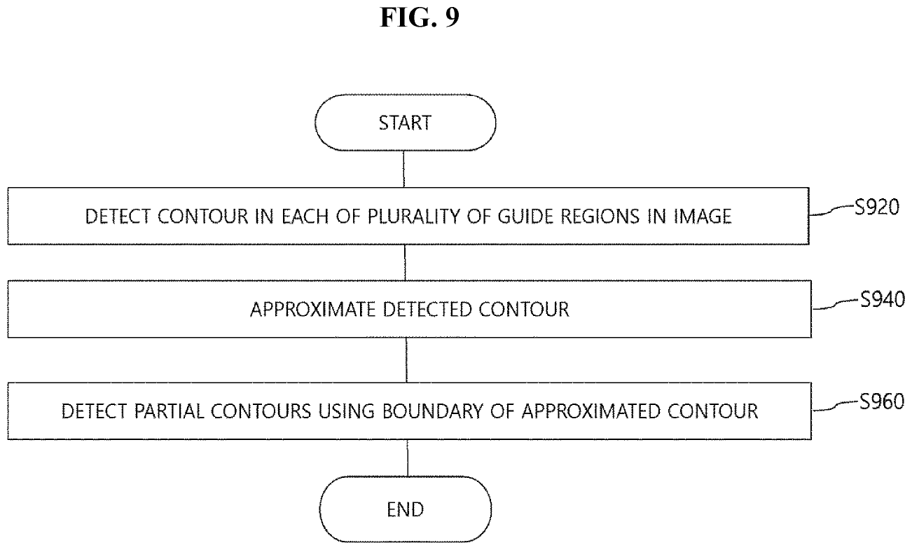

FIG. 9 is a diagram illustrating a process in which an electronic device detects a contour of an object in a plurality of guide regions according to an embodiment.

In S920, an electronic device 1000 may detect a contour of an object in each guide region using the contour detection method corresponding to operation S840. For example, the electronic device 1000 may detect a contour of an object by extracting feature points in an image and connecting the extracted feature points. According to an embodiment, based on thresholds determined for partial regions in an image, the electronic device 1000 may detect a contour from a guide region of a binarized image. According to an embodiment, the electronic device 1000 may determine contours having an area larger than a preset area by clustering contours detected from the binarized guide region.

In S940, the electronic device 1000 may approximate the contour detected for each guide region. For example, by approximating a plurality of contours extracted from the binarized guide region, the electronic device 1000 may determine a contour having a relatively large area among the plurality of contours. According to an embodiment, the electronic device 1000 may smooth a boundary of the largest contour by removing some contours from among the plurality of contours in the guide region.

In S960, the electronic device 1000 may detect partial contours using a boundary of the approximated contour. For example, the electronic device 1000 may determine a first partial contour related to nostrils and a second partial contour related to an animal's philtrum line by clustering the contours detected from the binarized guide region according to a predetermined criterion.

The electronic device 1000 may determine the intensity of pixels in an ellipse formed based on a contour detected according to the method shown in FIG. 9 and may determine a probability that the contour detected in the guide region corresponds to an object on the basis of the intensity of pixels in the ellipse.

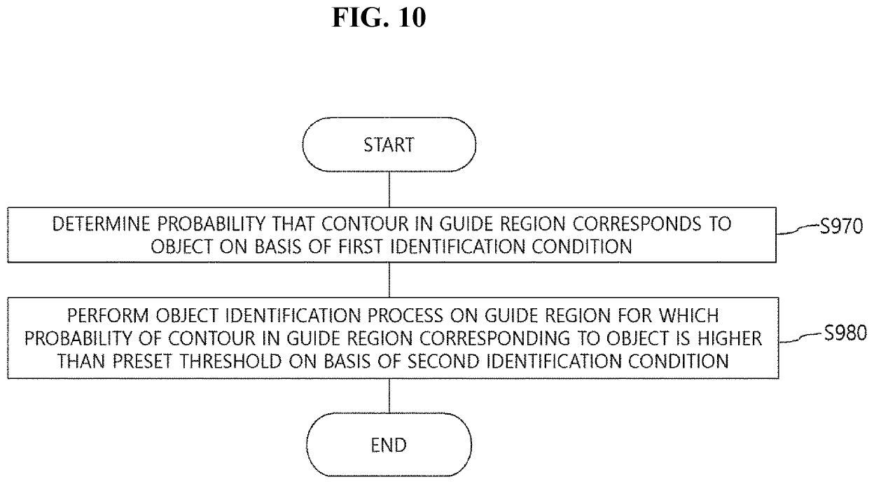

FIG. 10 is a diagram illustrating a process in which an electronic device detects a contour from at least one binarized guide region image and identifies the type of object on the basis of the detected contour according to an embodiment.

According to an embodiment, an electronic device 1000 may binarize a plurality of guide regions in an image and detect a contour of an object from each of the plurality of binarized guide regions. In S970, for example, the electronic device 1000 determines a first identification condition on the basis of contour components of contours detected from the guide regions and may determine a probability that each contour in the guide region corresponds to an object on the basis of the determined first identification condition. The electronic device 1000 may remove guide regions in which the probability that each contour in the guide region corresponds to the object is lower than a preset threshold from among the guide regions and may perform a secondary object identification process on only guide regions in which the probability that each contour in the guide region corresponds to the object is higher than the preset threshold.

For example, the electronic device 1000 may detect a first partial contour related to an animal's nostrils and a second partial contour related to an animal's philtrum line in the guide region. According to an embodiment, the electronic device 1000 may determine coordinate information of the first partial contour and the second partial contour detected from the guide region and may determine feature information on the basis of the determined coordinate information of the first partial contour and the second partial contour. The electronic device 1000 may identify a probability that each contour in a guide region corresponds to an object through a primary identification process, binarize a guide region for which a probability that each contour in the guide region corresponds to an object is higher than a preset threshold, and detect a first partial contour and a second partial contour from the binarized guide region.

In S980, the electronic device 1000 may determine a second identification condition regarding a relative location between the detected first partial contour and second partial contour from a guide region including a contour in which a probability of corresponding to an object is higher than the preset threshold, may determine feature information on the basis of scores for items of the second identification condition, and may perform a secondary identification process on the object in the image on the basis of a score indicated by the determined feature information.

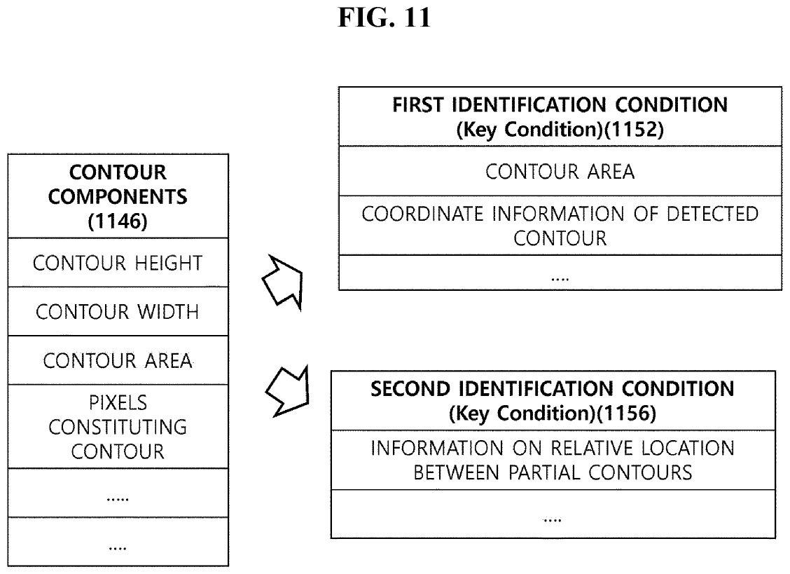

FIG. 11 is a diagram illustrating identification conditions used by an electronic device to determine a probability that an object detected in a guide region corresponds to a nose according to an embodiment.

For example, an electronic device 1000 determines a probability that a contour detected from each of a plurality of guide regions in an image corresponds to a nose using a first identification condition 1152 and performs a secondary object (e.g., an animal's nose) identification process on only a guide region for which the determined probability is higher than a predetermined threshold. Due to the electronic device 1000 performing an object recognition process (e.g., a process of recognizing an animal's nose object) on only some guide regions among a plurality of initially generated guide regions using a second identification condition 1156, it is possible to quickly and accurately perform a recognition process for an object in the image.

For example, the electronic device 1000 may acquire an image including at least a portion of an object and generate a plurality of guide regions for the acquired image. According to an embodiment, the electronic device 1000 detects contours of an object from each of the guide regions and determines a first identification condition 1152 using detected contour components 1146. The first identification condition 1152 may include the area of the contour and coordinate information of the detected contour. Also, according to an embodiment, the first identification condition 1152 may further include a ratio between the height and the width of the detected contour (aspect ratio) and a ratio between the area of the max contour and the area of the contour excluding the area of the max contour (solidity), but the present invention is not limited thereto. Also, according to an embodiment, the contour components 1146 may include the height of the contour, the width of the contour, the area of the contour, pixels constituting the contour, and coordinate information of the pixels constituting the contour.

According to an embodiment, the contour components 1146, the first identification condition 1152, and the second identification conditions 1156 that are used by the electronic device 1000 may be matched to predetermined identification numbers and prestored in a memory. The electronic device 1000 may determine a probability that a contour detected from each of a plurality of guide regions corresponds to an object using the first identification condition 1152 and may detect at least one partial contour from at least one guide region including a contour for which a probability of corresponding to an object is higher than a preset threshold. For example, the electronic device 1000 may detect a first partial contour and a second partial contour from the at least one guide region. The electronic device 1000 may determine a second identification condition 1156 using information on relative locations of partial contours on the basis of coordinate information of the detected first partial contour and coordinate information of the second partial contour. For example, the electronic device 1000 may determine the second identification condition using information on a relative location between the coordinate information of the first partial contour detected from the at least one guide region and the coordinate information of the second partial contour detected from the at least one guide region.

According to an embodiment, the second identification condition 1156 may include a condition regarding the locations of a vertical nose line contour and a nostril contour, a condition regarding the location range of the contour of both nostrils, a condition regarding the location range of a vertical nose contour and a nostril contour, a condition regarding the overlapping range of a vertical nose contour and a nostril contour, and a condition regarding the maximum size of a nostril contour, but the present invention is not limited thereto.

According to another embodiment, the second identification condition 1156 may include a first partial identification condition regarding whether the largest Y-axis component value in the coordinate information of the second partial contour is smaller than the largest Y-axis component value in the coordinate information of the first partial contour, a second partial identification condition regarding whether the central line of the first partial contour overlaps the central line of the second partial contour, and a third partial identification condition regarding whether the entire area of the first partial contour is less than or equal to a preset threshold area.

For example, first, the electronic device 1000 may detect, through an identification process, a first partial contour related to an animal's nostril and a second partial contour related to an animal's philtrum line from a guide region in which a probability of corresponding to an object is higher than or equal to a preset threshold and may determine coordinate information of the first partial contour and coordinate information of the second partial contour. The electronic device 1000 may identify whether a vertical node line part in the image is located under a nostril by comparing the largest Y-axis component value in the coordinate information of the second partial contour (e.g., the contour of a philtrum line) and the largest Y-axis component value in the coordinate information of the first partial contour (e.g.; the contour of a nostril).

According to another embodiment, the electronic device 1000 may identify whether the first partial contour is located in a first region range preset in the image on the basis of the coordinate information of the first partial contour or may identify whether the second partial contour is located in a second region range preset in the image on the basis of the coordinate information of the second partial contour. When the first partial contour is located in the first region range preset in the image on the basis of the coordinate information of the first partial contour and when the second partial contour is located in the second region range present in the image on the basis of the coordinate information of the second partial contour, the electronic device 1000 may identify that the object in the guide region is a nose.

According to another embodiment, based on the coordinate information of the first partial contour, the electronic device 1000 may identify whether the rightmost x-axis component value of the contour of the left nostril in the first partial contour and the leftmost x-axis component value of the contour of the right nostril in the first partial contour are not included in the x-axis component range of the philtrum line in the second partial contour. When the rightmost x-axis component value of the contour of the left nostril in the first partial contour and the leftmost x-axis component value of the contour of the right nostril in the first partial contour are not included in the x-axis component range of the philtrum line in the second partial contour, the electronic device 1000 may identify that the object in the guide region is a nose.

According to another embodiment, based on the coordinate information of the first partial contour and the coordinate information of the second partial contour, the electronic device 1000 may determine an area where the first partial contour and the second partial contour overlap each other. The electronic device 1000 may identify whether the area where the first partial contour and the second partial contour overlap each other is in a preset range and may identify that the object in the guide region is a nose when the area where the first partial contour and the second partial contour overlap each other is in the preset range.

According to another embodiment, the electronic device 1000 may determine the area of the first partial contour on the basis of the coordinate information of the first partial contour and may identify that the type of object in the guide region is a nose only when the determined area of the first partial contour is in the preset range.

According to an embodiment, when the first partial contour and the second partial contour detected from the guide region do not satisfy even one of the second identification conditions, the electronic device 1000 may not identify the type of object in the guide region as a nose. However, according to another embodiment, when the first partial contour and the second partial contour satisfy all the second identification conditions 1156, the electronic device 1000 may identify that the object in the guide region is a nose.

Also, according to an embodiment, the electronic device 1000 may determine a score for each item of the second identification condition on the basis of the coordinate information of the first partial contour and the coordinate information of the second partial contour. The electronic device 1000 may determine a score for each item of partial identification conditions included in the second identification condition 1156 with respect to the first partial contour and the second partial contour and may determine feature information by weighted-summing the determined scores of the items of the second identification condition. Only when the final score indicated by the feature information is greater than or equal to a preset threshold may the electronic device 1000 identify that the object in the image is a nose.

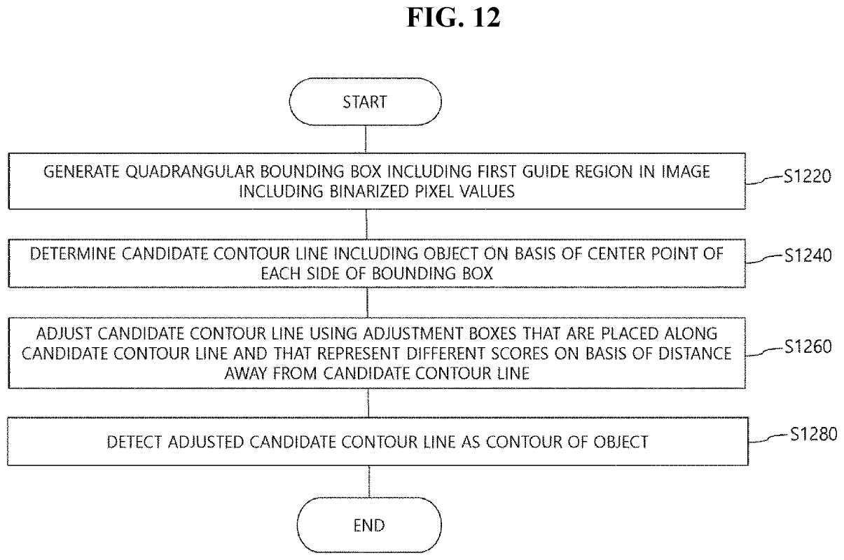

FIG. 12 is a flowchart illustrating a specific method of an electronic device detecting a contour line from a binarized guide region image according to an embodiment.

In S1220, an electronic device 1000 may generate a quadrangular bounding box including a first guide region in an image including binarized pixel values. For example, the electronic device 1000 may generate a quadrangular bounding box by increasing a predetermined height and width from the first guide region.

In S1240, the electronic device 1000 may determine a candidate contour line including an object on the basis of the center point of each side of the bounding box. For example, the electronic device 1000 may identify the coordinates of the vertices of the bounding box and may identify the coordinates of the center points of the bounding box on the basis of the identified coordinates of the vertices of the bounding box. The electronic device 1000 may determine a candidate contour line using two adjacent central points among the identified coordinates of the center points. According to an embodiment, the candidate contour line generated by the electronic device 1000 may include any straight line or curved line starting from one of the two adjacent center points and ending at the other center point.

In S1260, the electronic device 1000 may adjust the candidate contour line using adjustment boxes representing different scores on the basis of a distance away from the candidate contour line arranged along a candidate contour. For example, the electronic device 1000 may generate a first adjustment box bidirectionally spaced a first distance apart from the candidate contour line and may generate a second adjustment box bidirectionally spaced a second distance apart from the candidate contour line. The electronic device 1000 may assign a first adjustment score to the first adjustment box and may assign a second adjustment score to the second adjustment box.

The electronic device 1000 may determine scores for partial candidate contour lines in the currently generated candidate contour lines using a plurality of adjustment boxes representing different scores. The electronic device 1000 may adjust the entire candidate contour line by adjusting partial candidate contour lines on the basis of scores for the partial candidate contour lines.

According to an embodiment, the electronic device 1000 may smooth the adjusted candidate contour line. According to an embodiment, the electronic device 1000 may smooth the adjusted candidate contour line using a preset median filter.

In S1280, the electronic device 1000 may detect the adjusted candidate contour line as a contour of the object in the guide region. According to an embodiment, the electronic device 1000 may detect the smoothed candidate contour line as a contour of an object in each of at least one guide region.

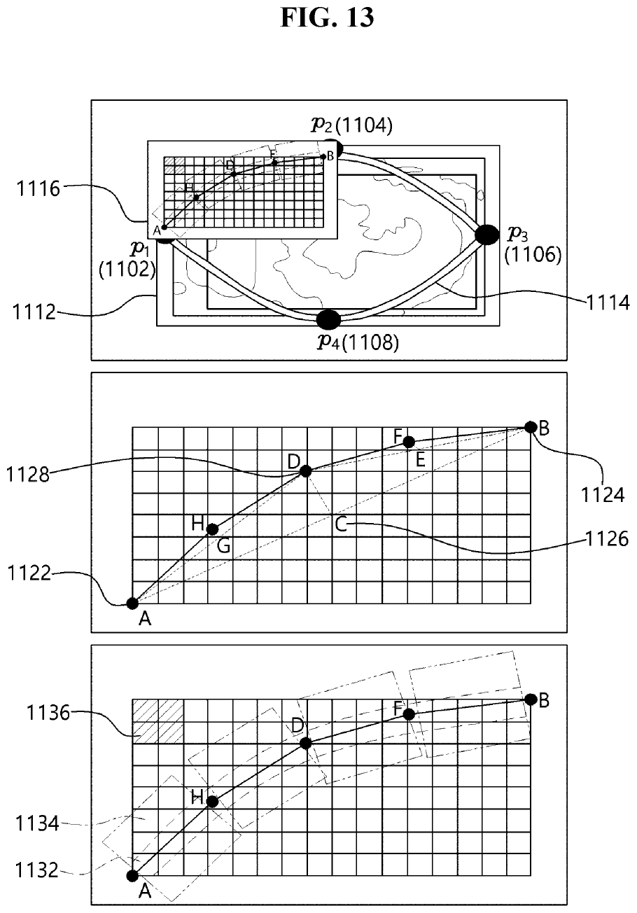

FIG. 13 is a reference diagram illustrating a specific method of an electronic device detecting a contour from a binarized guide region image according to an embodiment.

An electronic device 1000 may generate a quadrangular bounding box 1112 including a first guide region including a binarized image. According to another embodiment, the electronic device 1000 may generate the quadrangular bounding box 1112 shown in FIG. 13 only for some guide regions in which a probability that a counter detected in a corresponding guide region corresponds to an object is higher than or equal to a predetermined threshold among a plurality of guide regions.

The electronic device 1000 may identify the coordinates of the vertices of the bounding box 1112 and may identify the coordinates of center points 1102, 1104, 1106, and 1108 of the bounding box on the basis of the identified coordinates of the vertices. According to an embodiment, the electronic device 1000 may generate any arc by connecting two adjacent center points among the identified center points. For example, the electronic device 1000 may detect any candidate contour 1116 that has the center point 1102 and the center point 1104 of the bounding box as a start point and an end point, respectively. According to another embodiment, the electronic device 1000 may detect any candidate contour 1114 that has the center point 1106 and the center point 1108 of the bounding box as a start point and an end point, respectively.

More specifically, since candidate contours 1114 of FIG. 13 may be generated for some guide regions among the plurality of guide regions, the electronic device 1000 may generate a plurality of candidate contours 1114.

For example, a method of the electronic device 1000 detecting a candidate contour using two adjacent center points of the bounding box will be described in detail. For example, it is assumed that center points of the bounding box that are currently identified by the electronic device 1000 are point A 1122 and point B 1124. The electronic device 1000 may generate a straight line that connects point A and point B and may identify center point C 1126 of the generated straight line. The electronic device 1000 may identify point D 1128 that is perpendicular to the straight line connecting point A and point B and separated by a preset distance from center point C 1125. The electronic device 1000 may detect a primary candidate contour by connecting point A 1122, point B 1124, and point D 1128.

Similarly to the method of detecting the primary candidate contour using point A 1122 and point B 1124, the electronic device 1000 according to the present disclosure may detect a secondary candidate contour between the identified point A 1122 and point D 1128 using point A 1122 and point B 1128. Also, the electronic device 1000 may detect the secondary candidate contour using point D 1128 and point B 1124 in a similar way. By repeating the above-described scheme, the electronic device 1000 may determine an optimal candidate contour line that connects two adjacent center points of the bounding box.

Also, the electronic device 1000 may generate adjustment boxes representing different scores according to the determined candidate contour line. For example, the electronic device 1000 may generate a first adjustment box 1132 spaced a first distance apart from the candidate contour line and may generate a second adjustment box 1134 spaced a second distance apart from the candidate contour line. The electronic device 1000 may assign different adjustment scores to the adjustment boxes. According to an embodiment, the electronic device 1000 may assign an adjustment score of zero or a negative adjustment score to regions 1136 other than the first adjustment box and the second adjustment box.

By identifying the coordinates of pixels through which candidate contour lines pass and identifying whether the identified coordinates of the pixels belong to the first adjustment box 1132 or the second adjustment box 1134, the electronic device 1000 may determine contour scores for the candidate contour lines. When the contour scores determined for the candidate contour lines are smaller than or equal to a preset threshold, the electronic device 1000 may detect a contour from a guide region including a binarized image. However, when the contour scores determined for the candidate contour lines are larger than the preset threshold, the electronic device 1000 may detect the corresponding contour as the contour of the object. That is, by determining contour scores for candidate contour lines using a plurality of adjustment boxes placed along the candidate contour lines and comparing the contour scores to a preset threshold, the electronic device 1000 may adjust the candidate contour lines.

More specifically, a binarized image including black and white regions may be included in the bounding box 1112 where any candidate contour 116 generated by the electronic device 1000 is shown. When the white region in the binarized image is in the region of the first adjustment box 1132 formed around the candidate contour line, the electronic device 1000 may assign a slightly higher score (e.g., an adjustment score assigned to the first score box) to a pixel corresponding to the candidate contour line. When the white region in the binarized image is in the region of the second adjustment box 1145, the electronic device 1000 may assign a slightly lower score (an adjustment score assigned to the second adjustment box) to a pixel corresponding to the candidate contour line.

The electronic device 1000 may assign scores to pixels corresponding to the candidate contour line by performing the above process on each guide region (in which a probability of corresponding to an object is higher than or equal to a preset threshold) and may determine a contour score for the candidate contour line for each guide region in which the probability of corresponding to the object is higher than or equal to the preset threshold by summing the scores assigned to the pixels. The electronic device 1000 may determine a final contour from candidate contours for each guide region (which is a guide region in which a probability of corresponding to an object is higher than or equal to the preset threshold) on the basis of the contour score obtained according to the above method.

That is, the electronic device 1000 according to the present disclosure may adjust the candidate contour line using the adjustment boxes representing different scores and may detect the adjusted candidate contour line as a final contour of the object in the guide region.

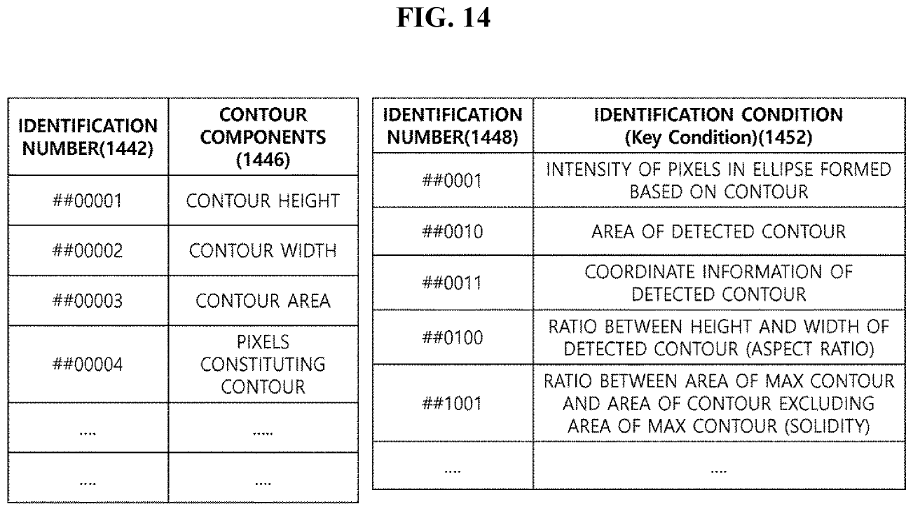

FIG. 14 is a diagram illustrating a first identification condition used by an electronic device to determine a probability that an object detected in a guide region corresponds to an eye according to an embodiment.

The electronic device 1000 does not extract a feature vector to be used in an artificial intelligence calculation from all guide regions but may determine a probability that a contour detected in each guide region corresponds to an object and may identify objects using only guide regions for which the determined probability is higher than or equal to a preset threshold. That is, the electronic device 1000 may determine a contour component 1446 forming a contour in a guide region including a binarized image, determine a predetermined first identification condition 1452 on the basis of the contour component, and determine whether to extract a feature vector from a specific guide region on the basis of the determined contour component and identification condition.

According to an embodiment, prior to a process of the electronic device 1000 secondarily determining an object by using artificial intelligence computation, a contour component 1446 and identification conditions 1452 necessary for performing primary object determination on a plurality of guide regions in the image may be identified by an identification number 1442 and an identification number 1448. The electronic device 1000 may match the identification number 1442 and the contour component 1446 and match the identification number 1448 and the identification condition 1452. The electronic device 1000 may store the matched identification number 1442 and contour component 1446 and the matched identification number 1448 and identification condition 1452 in a memory of the electronic device.

According to an embodiment, the contour component 1446 used by the electronic device 1000 may include information on the height of a contour extracted from a guide region, the width of the contour, the area of the contour, pixels constituting the contour, and the coordinates of the pixels constituting the contour. Also, according to an embodiment, based on the contour component, the identification condition used by the electronic device 1000 may include the intensity of pixels in an ellipse formed with respect to the contour, the area of the detected contour, coordinate information of the detected contour, a ratio between the height and width of the detected contour (aspect ratio), or a ratio between the area of the max contour and the area of the contour excluding the area of the max contour.

According to an embodiment, by applying different weights to the determined identification conditions, the electronic device 1000 may determine a probability that a contour in each of at least one guide region corresponds to an object. For example, the electronic device 1000 may identify intensity values of the pixels in the ellipse formed with respect to the contour detected in the guide region and may assign a first score to item ##0001 according to the identified intensity values. Also, the electronic device 1000 may assign a second score to item ##0100 according to the ratio between the height and width of the contour detected in the guide region (aspect ratio). Also, the electronic device 1000 may assign a third score to item ##1001 according to the ratio between the area of the max contour detected in the guide region and the area of the contour excluding the area of the max contour (solidity). Likewise, the electronic device 1000 may assign scores according to the degrees to which the contour detected from the guide region corresponds to items of another identification condition.

The electronic device 1000 may determine a probability that a contour detected from a guide region corresponds to an object on the basis of the sum of the scores assigned for the items of each identification condition. Also, according to an embodiment, by determining different weights for identification conditions and weighted-summing scores for the identification conditions according to the different weights rather than simply summing the scores corresponding to the identification conditions, the electronic device 1000 may determine a probability that a contour in a guide region corresponds to an object.

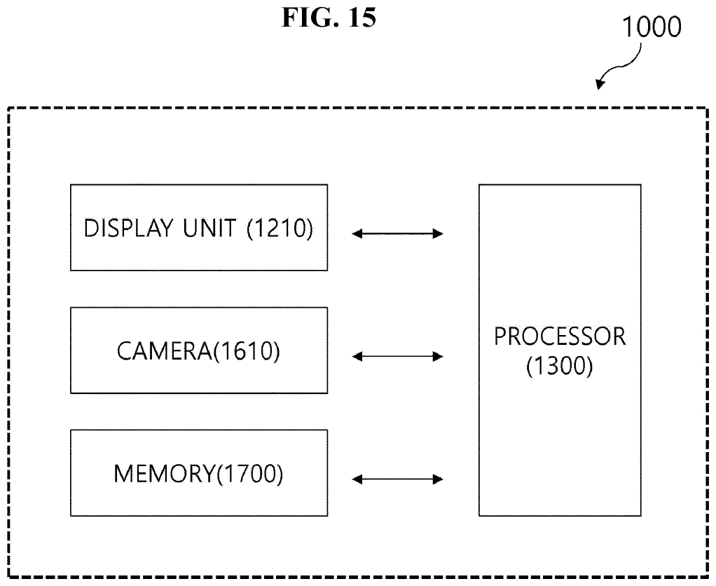

FIG. 15 is a block diagram of an electronic device according to an embodiment.

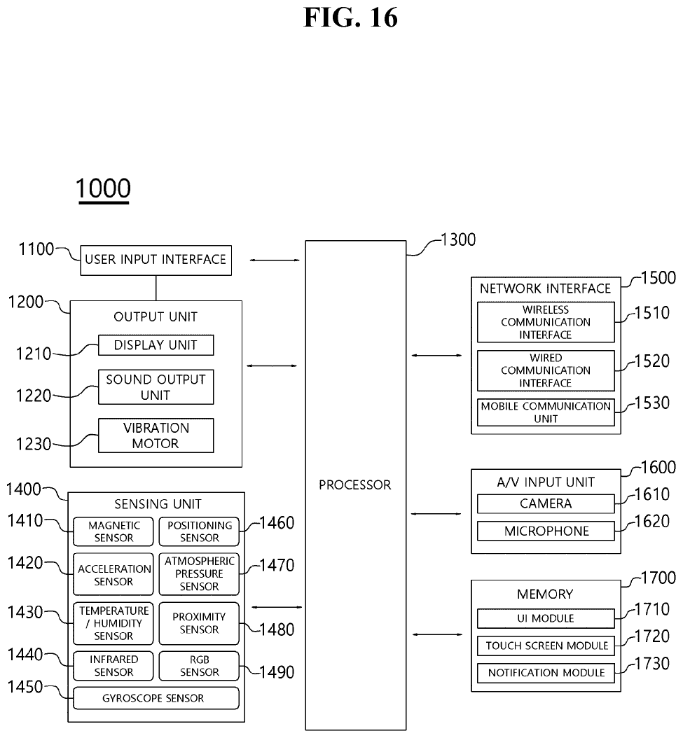

FIG. 16 is a block diagram of an electronic device according to another embodiment.

As shown in FIG. 15, an electronic device 1000 may include a processor 1300, a memory 1700, a camera module 1610, and a display unit 1210. However, not all of the illustrated components are essential components. The electronic device 1000 may be implemented with more components than the illustrated components, or the electronic device 1000 may be implemented with fewer components than the illustrated components.

For example, as shown in FIG. 16, in addition to a processor 1300, a memory 1700, a camera module 1610, and a display unit 1210, an electronic device 1000 according to an embodiment may additionally include a user input interface 1100, an output unit 1200 including a sound output unit 1220 and a vibration motor 1230, a sensing unit 1400, a network interface 1500, an audio/video (A/V) input unit 1600, and a fastening part (not shown).

The user input interface 1100 refers to a means for a user to input a sequence for controlling the electronic device 1000. For example, the user input interface 1100 includes a keypad, a dome switch, and a touchpad (a touch-capacitive type, a pressure-resistive type, an infrared-beam sensing type, a surface-acoustic wave type, an integral strain gauge type, a piezo-effect, or the like), a jog wheel, and a jog switch, but the present invention is not limited thereto. The user input interface 1100 may receive a user's input sequence of a screen that is output to a display by the electronic device 1000. Also, the user input interface 1100 may receive a user's touch input of touching a display or may receive a key input through a graphics user interface on the display.

The output unit 1200 may output an audio signal, a video signal, or a vibration signal, and the output unit 1200 may include a display unit 1210, a sound output unit 1220, and a vibration motor 1230.

The display unit 1210 includes a screen for displaying information processed by the electronic device 1000. Also, the screen may display at least one guide region and a guide message for enabling the user to capture an animal image. Also, the sound output unit 1220 outputs audio data that is received from the network interface 1500 or stored in the memory 1700. Also, the sound output unit 1220 outputs a sound signal related to a function performed by the electronic device 1000. The vibration motor 1230 may output a vibration signal. For example, the vibration motor 1230 may output a vibration signal corresponding to an output of functions performed by the electronic device 1000.

Typically, the processor 1300 controls the entire operation of the electronic device 1000. For example, by executing programs stored in the memory 1700, the processor 1300 may generally control the user input interface 1100, the output unit 1200, the sensing unit 1400, the network interface 1500, the A/V input unit 1600, and the like. Also, by executing programs stored in the memory 1700, the processor 1300 may perform the function of the electronic device 1000 described above with reference to FIGS. 1 to 14.

Specifically, the processor 1300 may acquire a user input that touches the screen of the electronic device by controlling the user input unit. According to an embodiment, the processor 1300 may control a microphone to acquire the user's voice. The processor 1300 may acquire images including objects on the basis of the user input. When an object is not identified in an image, the processor 1300 may re-acquire an image including an object on the basis of a user input re-received from the user.

According to an embodiment, by executing one or more instructions stored in the memory, the processor 1300 may determine a plurality of guide regions of different scales corresponding to the object in the acquired image. The processor 1300 may identify the type of object in the image on the basis of feature information that is for identifying the object and that is determined from some guide regions among the plurality of guide regions. When the identified type of object is identified as an object related to an animal's eye or when the identified type of object is identified as an object related to an animal's nose, the processor 1300 may store at least one pixel value of the image including the object.

According to an embodiment, by executing one or more instructions stored in the memory, the processor 1300 may determine a first guide region corresponding to the object such that the first guide region includes a preset reference pixel in the acquired image. By scaling the determined first guide region according to a preset scale, the processor 1300 may determine at least one second guide region corresponding to the object.

According to an embodiment, by executing one or more instructions stored in the memory, the processor 1300 may remove noise in the acquired image by applying a kernel to pixel values of the acquired image, convert the pixel values in the image from which the noise is removed, and determine a plurality of guide regions of different scales in the image with the converted pixel values.

According to an embodiment, by executing one or more instructions stored in the memory, the processor 1300 may detect a contour of the object in each of the plurality of guide regions, determine a probability that the detected contour corresponds to the object, and identify the type of object in the image on the basis of feature information determined from some guide regions each including a contour for which a determined probability is higher than a preset threshold.

According to an embodiment, by executing one or more instructions stored in the memory, the processor 1300 may divide the image with the converted pixel values into at least one or more partial regions of a preset size, determine thresholds for the partial regions in order to binarize pixel values included in the partial regions on the basis of the pixel values of the partial regions, binarize the pixel values in the partial regions on the basis of the determined thresholds, and detect a contour of the object in each of the plurality of guide regions in the image including the binarized pixel values.

According to an embodiment, by executing one or more instructions stored in the memory, the processor 1300 may determine a first identification condition for identifying the object using contour components in the detected contour. By applying different weights to the determined first identification condition, the processor 1300 may determine a probability that the contour in each of the plurality of guide regions corresponds to the object.

As described above, the contour components according to the present disclosure may include the height of the detected contour, the width of the contour, the area of the detected contour, the area of the max contour among the detected contours, and pixels constituting the contour. The first identification condition may include the intensity of pixels in an ellipse formed based on the detected contour, the area of the detected contour, the coordinates of the detected contour, a ratio between the height and width of the detected contour, and a ratio between the area of the max contour and the area of the contour excluding the area of the max contour.

According to an embodiment, by executing one or more instructions stored in the memory, the processor 1300 may detect a first partial contour related to an animal's nose and a second partial contour related to an animal's philtrum line from some guide regions each including a contour for which a determined probability is higher than a preset threshold, determine coordinate information of the detected first partial contour and coordinate information of the detected second partial contour, determine a second identification condition regarding a relative location between the detected first partial contour and the detected second partial contour, determine scores for items of the second identification condition on the basis of the coordinate information of the first partial contour and the coordinate information of the second partial contour, determine feature information on the basis of the determined scores for the items of the second identification condition, and identify whether the object identified from the image is an object related to an animal's nose using the feature information determined according to the scores for the items of the second identification condition.

According to an embodiment, by executing one or more instructions stored in the memory, the processor 1300 may determine feature information for identifying the object from the some guide regions each including the contour for which the determined probability is higher than the preset threshold, identify the type of object in each of the some guide regions using the determined feature information, determine the frequency of guide regions in which objects of the same type are identified among the types of objects identified in the some guide regions; and determine the type of object in the image on the basis of the determined frequency.

According to an embodiment, by executing one or more instructions stored in the memory, the processor 1300 may determine a gradient of pixels of the image in the some guide regions each including the contour for which the determined probability is higher than the preset threshold and may determine feature information using the determined gradient.

According to an embodiment, by executing one or more instructions stored in the memory, the processor 1300 may resize the some guide regions each including the contour for which the determined probability is higher than the preset threshold and may determine feature information in each of the some resized guide regions.

According to an embodiment, by executing one or more instructions stored in the memory, the processor 1300 may identify the type of object in the image by inputting the feature information determined from each of the some guide regions to an artificial intelligence model that outputs the type of object in the image when the feature information is input.

The second identification condition may include a first partial identification condition regarding whether the largest Y-axis component value in the coordinate information of the second partial contour is smaller than the largest Y-axis component value in the coordinate information of the first partial contour, a second partial identification condition regarding whether a central line of the first partial contour overlaps a central line of the second partial contour, and a third partial identification condition regarding whether the entire area of the first partial contour is less than or equal to a preset threshold area.

The sensing unit 1400 may sense the state of the electronic device 1000 or the state around the electronic device 1000 and may deliver the sensed information to the processor 1300. The sensing unit 1400 may include at least one of a magnetic sensor 1410, an acceleration sensor 1420, a temperature/humidity sensor 1430, an infrared sensor 1440, a gyroscope sensor 1450, and a positioning sensor (e.g., a Global Positioning System (GPS) sensor) 1460, an atmospheric pressure sensor 1470, a proximity sensor 1480, and an RGB sensor (illuminance sensor) 1490, but the present invention is not limited thereto. The function of each sensor can be intuitively inferred from the name thereof by those skilled in the art, and thus a detailed description thereof will be omitted.

The network interface 1500 may include one or more elements that allow the electronic device 1000 to communicate with the server 2000 and other devices (not shown). Another device (not shown) may be a computing device such as the electronic device 1000, a sensing device, or the like, but the present invention is not limited thereto. For example, the network interface 1500 may include a wireless communication interface 1510, a wired communication interface 1520, and a mobile communication unit 530.

The wireless communication interface 1510 may include a short-range wireless communication unit, a Bluetooth communication unit, a Near Field Communication unit, a WLAN (Wi-Fi) communication unit, a Zigbee communication unit, an Infrared Data Association (IrDA) communication unit, a Wi-Fi Direct (WFD) unit, and the like, but the present invention is not limited thereto. The wired communication interface 1520 may provide wired connection to the server 2000 or the electronic device 1000.

The mobile communication unit 1530 may transmit and receive radio signals to and from at least one of a base station, an external terminal, and a server over a mobile communication network. Here, the radio signals may include a voice signal, a video call signal, or various types of data corresponding to transmission or reception of text or multimedia messages.

According to an embodiment, the network interface 1500 may transmit information on an image of an object or information on videos each composed of a plurality of frames to a server under the control of a processor. Also, the network interface 1500 may further receive information on a result of recognizing the object in the image from the server.

The A/V input unit 1600 is for inputting an audio signal or a video signal and may include a camera 1610, a microphone 1620, and the like. The camera 1610 may obtain a picture frame such as a still image or a video through an image sensor in a video call mode or a photographing mode. An image captured through the image sensor may be processed through the processor or a separate image processing unit (not shown). For example, the camera module 1610 may acquire an animal image multiple times on the basis of a user input.

The microphone 1620 receives and processes an external sound signal into electric voice data. For example, the microphone 1620 may receive a sound signal from an external device or a user. The microphone 1620 may receive the user's voice input. The microphone 1620 may use various noise removal algorithms for removing noise generated while receiving an external sound signal.

The memory 1700 may store a program for processing and controlling of the processor 1300 and may store data that is input to or output from the electronic device 1000. Also, the memory 1700 may further store an image including an object, information on a video, information on at least one guide region shown in an image or video, information on a contour detected from a guide region, information on a result of identifying an object in each guide region, a plurality of contour components for determining a probability that a contour for each guide region corresponds to an object, or information on a first identification condition or a second identification condition which is acquired based on a user input by the electronic device 1000.

The memory 1700 may include at least one type of storage medium selected from among a flash memory-type memory, a hard disk-type memory, a multimedia card micro-type memory, a card-type memory (e.g., an SD or XD memory), a random access memory (RAM), a static random access memory (SRAM), a read-only memory (ROM), an electrically erasable programmable read-only memory (EEPROM), a programmable read-only memory (PROM), a magnetic memory, a magnetic disk, and an optical disc.

Programs stored in the memory 1700 may be classified into a plurality of modules according to their functions and, for example, into a user interface (UI) module 1710, a touch screen module 1720, a notification module 1730, and the like.

The UI module 1710 may provide a specialized UI, GUI, or the like that interoperates with the electronic device 1000 on a per-application basis. The touch screen module 1720 may sense a user's touch gesture on a touch screen and deliver information regarding the touch gesture to the processor 1300. The touch screen module 1720 according to some embodiments may recognize and analyze a touch code. The touch screen module 1720 may be configured with separate hardware including a controller.

The notification module 1730 may generate a signal for informing about the occurrence of an event in the electronic device 1000. Examples of events occurring in the electronic device 1000 include call signal reception, message reception, key signal input, schedule notification, and the like. The notification module 1730 may output a notification signal in the form of a video signal through the display unit 1210, output a notification signal in the form of an audio signal through the sound output unit 1220, or output a notification signal in the form of a vibration signal through the vibration motor 1230.

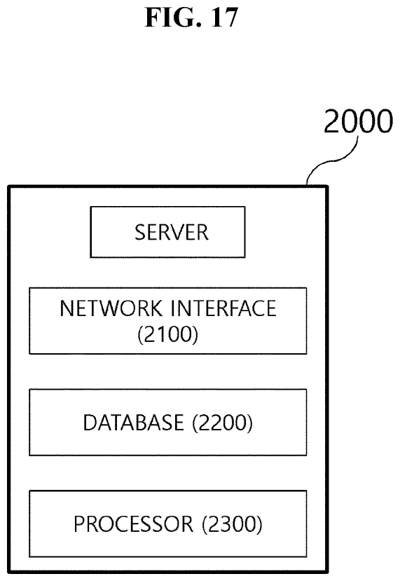

FIG. 17 is a block diagram of a server according to an embodiment.

A server 2000 may include a network interface 2100, a database 2200, and a processor 2300. The network interface 2100 may correspond to the network interface 1500 of the shown electronic device 1000. For example, the network interface 2100 may receive information on a video or an image obtained by capturing objects from electronic device 1000 or may transmit information on a result of recognizing the received image or video to the electronic device 1000.

The database 2200 may correspond to the memory 1700 of the electronic device 1000 shown in FIG. 16. For example, the database 2200 may further store an image including an object, information on a video, information on at least one guide region shown in an image or video, information on a contour detected from a guide region, information on a result of identifying an object in each guide region, a contour component for determining a probability that a contour for each guide region corresponds to an object, or information on an identification condition, which is acquired based on a user input.

Typically, the processor 2300 controls the overall operation of the server 2000. For example, by executing programs stored in the DB 2200 of the server 2000, the processor 2300 may generally control the DB 2200 and the network interface 2100. Also, by executing programs stored in the DB 2100, the processor 2300 may perform some of the operations of the electronic device 1000 described with reference to FIGS. 1 to 14. For example, the processor 2300 may receive information on an image including an object from the electronic device, determine at least one guide region corresponding to the object in the received image, determine feature information for identifying an object from the at least one guide region, and identify whether the object in the image is an object related to an animal's nose or an object related to an animal's eye on the basis of the determined feature information. Also, the processor 2300 may transmit a result of analyzing the image to the electronic device 1000.

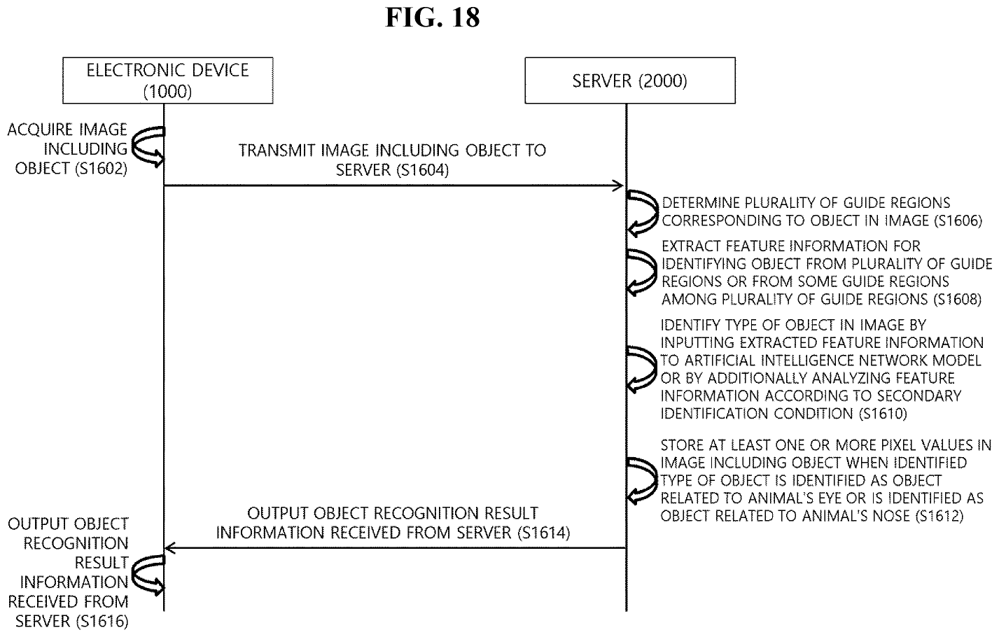

FIG. 18 is a diagram illustrating a process of identifying an object in an image by an electronic device and a service interworking with each other according to an embodiment.

In S1602, an electronic device 1000 may acquire an image including an object related to an animal's nose or an object related to an animal's eye. According to another embodiment, the electronic device 1000 may acquire an image including an object related to an animal's nose, partial objects related to an animals' nose, an object related to an animal's eye, and partial objects related to an animal's eye. According to an embodiment, the electronic device 1000 may acquire a video including an animal image using at least one camera in the electronic device.

In S1604, the electronic device 1000 may transmit an image including the object acquired in S1602 to a server 2000. According to an embodiment, the electronic device 1000 may transmit information on a video or image including an animal to the server 2000. In S1606, the server 2000 may determine a plurality of guide regions corresponding to the object in the image. For example, the server 2000 may determine a first guide region in the image and may determine second guide regions by scaling the determined first guide region according to a preset scale.

In S1608, the server 2000 may determine feature information for identifying the object from the plurality of guide regions or some guide regions extracted from among the plurality of guide regions. According to an embodiment, through a primary object identification process, the server 2000 may remove a guide region that does not satisfy a predetermined probability that the detected contour corresponds to the object and may determine feature information from only some guide regions in which a probability that the detected contour corresponds to the object is high.

In S1610, the server 2000 may identify the type of object in the image by inputting the extracted feature information to a pre-trained artificial intelligence model. According to another embodiment, the server 2000 may detect a first partial contour and a second partial contour from a guide region in which a probability of corresponding to a nose is higher than or equal to a preset threshold among initially generated guide region, determine a second identification condition on the basis of coordinate information of the first partial contour and coordinate information of the second partial contour, and identify the type of object in the image by additionally analyzing the feature information according to the second identification condition.

According to another embodiment, the server 2000 may correct feature information generated according to the first identification condition by weighted-summing scores for items of the second identification condition for the first partial contour and the second partial contour on the basis of the coordinate information of the first partial contour and the coordinate information of the second partial contour and may identify the object in the image on the basis of scores indicated by the corrected feature information.

In S1612, when the identified type of object in the image is identified as an animal's nose or partial objects related to an animal's nose or is identified as an animal's eye or partial objects related to an animal's eye, the server 2000 may store at least one pixel value in the image including the corresponding object in the database. In S1614, the server 2000 may analyze the image and transmit information on a result of recognizing the object in the image to the electronic device 1000. In S1616, the electronic device 1000 may output the information on the result of recognizing the object in the image, which is received from the server.

The method according to an embodiment may be implemented in the form of program instructions executable by a variety of computer means and may be recorded on a computer-readable medium. The computer-readable medium may include program instructions, data files, data structures, and the like alone or in combination. The program instructions recorded on the medium may be designed and configured specifically for an embodiment or may be publicly known and usable by those who are skilled in the field of computer software.

Also, a computer program device including a recording medium in which a program for performing the method according to the embodiment is stored may be provided. Examples of the computer-readable recording medium include a magnetic medium, such as a hard disk, a floppy disk, and a magnetic tape, an optical medium, such as a compact disc read-only memory (CD-ROM), a digital versatile disc (DVD), etc., a magneto-optical medium such as a floptical disk, and a hardware device specially configured to store and perform program instructions, for example, a read-only memory (ROM), a random access memory (RAM), a flash memory, etc. Examples of the program instructions include not only machine language code generated by a compiler, but also high-level language code executable by a computer using an interpreter or the like.

Although the embodiments of the present disclosure have been described in detail above, the scope of the present disclosure is not limited thereto but encompasses various modifications and improvements made by those skilled in the art using the basic concept of the present disclosure defined in the appended claims.

1. A method of an electronic device identifying an object in an image, the method comprising:
acquiring an image including the object;
determining a plurality of guide regions of different scales corresponding to the object in the acquired image;
identifying the type of object in the image on the basis of feature information that is for identifying the object and that is determined from some guide regions among the plurality of guide regions; and
storing at least one pixel value of the image including the object when the identified type of object is identified as an object related to an animal's eye or when the identified type of object is identified as an object related to an animal's nose.

2. The method of claim 1, wherein
the determining of a plurality of guide regions comprises:
determining a first guide region corresponding to the object such that the first guide region includes a preset reference pixel in the acquired image; and
determining at least one second guide region corresponding to the object by scaling the determined first guide region according to a preset scale, and
the feature information is determined from each of the first guide region and the second guide region.

3. The method of claim 2, wherein the first guide region is displayed on a screen of the electronic device, and the second guide region is not displayed on a screen of the electronic device.

4. The method of claim 2, further comprising:
removing noise in the acquired image by applying a kernel to pixel values in the acquired image;
converting the pixel values in the image from which the noise is removed; and
determining a plurality of guide regions of different scales in the image in which the pixel values are converted.

5. The method of claim 2, further comprising:
detecting a contour of the object in each of the plurality of guide regions;
determining a probability that the detected contour corresponds to the object; and
identifying the type of object in the image on the basis of feature information determined from the some guide regions that each include a contour for which a determined probability is higher than a preset threshold.

6. The method of claim 5, the detecting of a contour of the object comprises:
dividing an image with converted pixel values into at least one or more partial regions of a preset size;
determining thresholds for the partial regions in order to binarize pixel values included in the partial regions on the basis of the pixel values of the partial regions;
binarizing the pixel values in the partial regions on the basis of the determined thresholds; and
detecting a contour of the object in each of the plurality of guide regions in the image including the binarized pixel values.

7. The method of claim 5, wherein the determining of a probability that the detected contour corresponds to the object comprises:
determining a first identification condition for identifying the object using contour components in the detected contour; and
determining a probability that the contour in each of the plurality of guide regions corresponds to the object by applying different weights to the determined first identification condition.

8. The method of claim 7, wherein
the components comprise the height of the detected contour, the width of the contour, the area of the detected contour, the area of the max contour among the detected contours, and pixels constituting the contour, and
the first identification condition comprises the intensity of pixels in an ellipse formed based on the detected contour, the area of the detected contour, the coordinates of the detected contour, a ratio between the height and width of the detected contour, and a ratio between the area of the max contour and the area of the contour excluding the area of the max contour.

9. The method of claim 7, further comprising:
detecting a first partial contour related to an animal's nose and a second partial contour related to an animal's philtrum line from the some guide regions each including the contour for which the determined probability is higher than the preset threshold;
determining coordinate information of the detected first partial contour and coordinate information of the detected second partial contour;
determining a second identification condition regarding a relative location between the detected first partial contour and the detected second partial contour;
determining scores for items of the second identification condition on the basis of the coordinate information of the first partial contour and the coordinate information of the second partial contour;
determining feature information on the basis of the determined scores for the items of the second identification condition; and
identifying whether the object identified from the image is an object related to an animal's nose using the feature information determined according to the scores for the items of the second identification condition.

10. The method of claim 7, further comprising:
determining feature information for identifying the object from the some guide regions each including the contour for which the determined probability is higher than the preset threshold;
identifying the type of object in each of the some guide regions using the determined feature information;
determining the frequency of guide regions in which objects of the same type are identified among the types of objects identified in the some guide regions; and
determining the type of object in the image on the basis of the determined frequency.

11. The method of claim 10, wherein the determining of feature information comprises:
determining a gradient of pixels of the image in the some guide regions each including the contour for which the determined probability is higher than the preset threshold; and
determining feature information using the determined gradient.

12. The method of claim 10, wherein the determining of feature information comprises:
resizing the some guide regions each including the contour for which the determined probability is higher than the preset threshold; and
determining feature information in each of the some resized guide regions.

13. The method of claim 10, wherein the identifying of the type of object in each of the some guide regions comprises identifying the type of object in the image by inputting the feature information determined from each of the some guide regions to an artificial intelligence model that outputs the type of object in the image when the feature information is input.

14. The method of claim 9, wherein the second identification condition comprises a first partial identification condition regarding whether the largest Y-axis component value in the coordinate information of the second partial contour is smaller than the largest Y-axis component value in the coordinate information of the first partial contour, a second partial identification condition regarding whether a central line of the first partial contour overlaps a central line of the second partial contour, and a third partial identification condition regarding whether the entire area of the first partial contour is less than or equal to a preset threshold area.

15. The method of claim 13, wherein the artificial intelligence model comprises an input layer, an output layer, and one or more hidden layers between the input layer and the output layer, and comprises a machine learning model that is trained according to an artificial intelligence learning algorithm or an intelligence neural network model in which weights for the intensity of connections between the input layer, the output layer, and the hidden layers are updated.

16. An electronic device for identifying an object in an image, the electronic device comprising:
a display;
at least one camera;
a memory configured to store one or more instructions; and
at least one processor configured to execute the one or more instructions, wherein by executing the one or more instructions, the processor is configured to:
acquire an image including the object;
determine a plurality of guide regions of different scales corresponding to the object in the acquired image;
identify the type of object in the image on the basis of feature information that is for identifying the object and that is determined from some guide regions among the plurality of guide regions; and
store at least one pixel value of the image including the object when the identified type of object is identified as an object related to an animal's eye or when the identified type of object is identified as an object related to an animal's nose.

17. The electronic device of claim 16, wherein the at least one processor is configured to:
determine a first guide region corresponding to the object such that the first guide region includes a preset reference pixel in the acquired image;
determine at least one second guide region corresponding to the object by scaling the determined first guide region according to a preset scale; and
determine the feature information from each of the first guide region and the second guide region.

18. The electronic device of claim 17, wherein the at least one processor displays the first guide region on a screen of the electronic device and does not display the second guide region on a screen of the electronic device.

19. The electronic device of claim 17, wherein the at least one processor is configured to:
remove noise in the acquired image by applying a kernel to pixel values in the acquired image;
convert the pixel values in the image from which the noise is removed; and
determine a plurality of guide regions of different scales in the image in which the pixel values are converted.

20. A computer program product comprising a recording medium on which a program is stored for performing a method of an electronic device identifying an object in an image, the method comprising:
acquiring an image including the object;
determining a plurality of guide regions of different scales corresponding to the object in the acquired image;
identifying the type of object in the image on the basis of feature information that is for identifying the object and that is determined from some guide regions among the plurality of guide regions; and
storing at least one pixel value of the image including the object when the identified type of object is identified as an object related to an animal's eye or when the identified type of object is identified as an object related to an animal's nose.
